(19) United States
(12) Patent Application Publication
(10) Pub. No.: US 2023/0059838 A1
(43) Pub. Date: Feb. 23, 2023

(54) HEAT INPUT REDUCING STRUCTURE FOR AIRCRAFT, HEAT INPUT REDUCING SYSTEM, AIRCRAFT, AND AIRCRAFT MANUFACTURING METHOD

(71) Applicant: Mitsubishi Aircraft Corporation, Aichi (JP)

(72) Inventors: Tadahiko Suzuta, Tokyo (JP); Toshiyuki Umemoto, Aichi (JP); Hideyuki Kudo, Tokyo (JP); Takuo Oda, Tokyo (JP); Nobuhide Hara, Tokyo (JP)

(73) Assignee: Mitsubishi Aircraft Corporation, Aichi (JP)

(21) Appl. No.: 17/795,674

(22) PCT Filed: Jan. 22, 2021
(86) PCT No.: PCT/JP2021/002199

§ 371 Date: Jul. 27, 2022

(30) Foreign Application Priority Data
Jan. 27, 2020 (JP) 2020-010641

(51) Int. Cl. B64C 1/38; B64F 5/10; B05D 5/06; B05D 7/00; G02B 5/20

(52) U.S. Cl. CPC B64C 1/38; B64F 5/10; B05D 5/066; B05D 5/063; B05D 7/58; G02B 5/208

(57) ABSTRACT

An outer surface of a part of an airframe includes a mixed region in which a first color similar to a color applied to an adjacent region and a second color having a lower absorption rate of sunlight than the first color are mixed in a predetermined color distribution pattern. A reflective material that contributes to an increase in a reflection rate of sunlight is added to a part to which at least the first color is applied in the mixed region.

### TECHNICAL FIELD

The present disclosure relates to an aircraft and an aircraft manufacturing method. In particular, the present disclosure relates to a countermeasure against a heat input to an airframe of the aircraft which is caused by solar radiation.

### BACKGROUND ART

When an aircraft is parked outdoors, in a case where an airframe receives radiant energy of sunlight, a temperature of the airframe and an environmental temperature inside the airframe increases. In particular, in an aircraft internal compartment where an accessory such as a heat generating source is disposed and which is not actively ventilated, for example, in a non-pressurized compartment of a fuselage rear part, it is observed that the environmental temperature tends to increase to a higher temperature compared to other compartments.

In PTL 1, the inventor of the present disclosure proposes a heat discharge structure in which heat staying inside a fuselage is discharged outward.

### CITATION LIST

### Patent Literature

[PTL 1] Japanese Unexamined Patent Application Publication No. 2016-97731

### SUMMARY OF INVENTION

### Technical Problem

An object of the present disclosure is to provide heat input reducing structure for an aircraft, an aircraft including the structure, and an aircraft manufacturing method, which can reduce an increase in an environmental temperature inside the aircraft and can reduce a temperature increase in a member including a compartment, even when there is a limit to natural ventilation due to heat dissipation to outside air from the compartment inside the aircraft and a pressure difference between an inside and an outside of the compartment.

### Solution to Problem

The inventor of the present disclosure focuses on an exterior color of an airframe of an aircraft in designing heat of the aircraft. As a color(exterior color) of a coating film or a film applied to an outer surface of the airframe, a predetermined color is designated for each part of the airframe.

When the exterior color is a dark color such as a black color, a light absorption rate of the airframe is higher than that when the exterior color is a light color such as a white color. For example, whereas the light absorption rate of a black coating film is approximately 0.95, the light absorption rate of a white coating film is approximately 0.3. Absorbed light energy is converted into heat energy. Accordingly, the exterior color of the airframe cannot be ignored in view of a heat input to the airframe which is caused by sunlight.

Furthermore, the inventor considers a relationship between the exterior color and a part of the airframe to which the exterior color is applied.

When the inventor considers radiant energy of the sunlight incident on the airframe of the aircraft, incident intensity on an upper part of the airframe is generally higher than incident intensity on other parts, regardless of an orientation of the airframe when the aircraft is parked. An outside air temperature while the aircraft is parked is higher than an outside air temperature during flight of the aircraft, and the sunlight is incident on the upper part of the airframe during a daytime zone while the incident intensity is high and the outside air temperature is high. Therefore, contribution of light absorption on the upper part of the airframe to the amount of the heat input to the airframe is greater than that of other parts.

In this case, when the exterior color of the upper part of the airframe is the dark color, it is disadvantageous from a viewpoint of an increase in an environmental temperature inside the aircraft. However, the exterior color of the upper part of the airframe is less likely to be noticeable unless the airframe is viewed from above. Therefore, even when a color different from a designated color is applied to the upper part of the airframe, the color application is sufficiently allowable.

According to the present disclosure conceivable based on the above-described novel findings, there is provided a heat input reducing structure for an aircraft. An outer surface of a part of an airframe includes a mixed region in which a first color similar to a color applied to an adjacent region and a second color having a lower absorption rate of sunlight than the first color are mixed in a predetermined color distribution pattern. A reflective material that contributes to an increase in a reflection rate of sunlight is added to a part to which at least the first color is applied in the mixed region.

According to the present disclosure, there is provided an aircraft including an airframe and the heat input reducing structure applied to a part of the airframe.

In addition, according to the present disclosure, there is provided an aircraft manufacturing method for manufacturing an aircraft after coating an airframe. The method includes a step of forming a first coating film by applying a coating material of a first color similar to a color applied to an adjacent region in a predetermined color distribution pattern, to a mixed region located on an outer surface of a part of the airframe, and a step of forming a second coating film formed by transferring a coating material of a second color having a lower absorption rate of sunlight than the first color so that the first color and the second color are mixed.

According to the present disclosure, there is provided an aircraft manufacturing method for manufacturing an aircraft after coating an airframe. The method includes a step of forming a first coating film by applying a coating material of a first color similar to a color applied to an adjacent region in a predetermined color distribution pattern, to a mixed region located on an outer surface of a part of the airframe, and a step of forming a second coating film formed by using a coating material of a second color having a lower absorption rate of sunlight than the first color after masking a location to which the first color is applied so that the first color and the second color are mixed.

According to the present disclosure, there is provided an aircraft manufacturing method for manufacturing an aircraft after application of an exterior film to an airframe. The method includes a step of covering at least a part of the airframe with the exterior film including a mixed region. In the mixed region, a first color similar to a color applied to a region adjacent to the mixed region and a second color having a lower absorption rate of sunlight than the first color are mixed in a predetermined color distribution pattern.

In addition, according to the present disclosure, there is provided a heat input reducing structure for an aircraft which includes a structural member forming a non-pressurized compartment of the aircraft, and a heat blocking material that blocks heat radiated from a heat source located in the non-pressurized compartment for the structural member. The structural member includes a target region facing the heat source via the heat blocking material, and a mixed region located on an outer surface of an airframe, in which a first color similar to a color applied to an adjacent region in a direction along the outer surface and a second color having a lower absorption rate of sunlight than the first color are mixed in a predetermined color distribution pattern.

Furthermore, according to the present disclosure, there is provided a heat input reducing system for an aircraft which includes the heat input reducing structure including a heat blocking material, a fuselage of an aircraft, an air conditioner disposed in the non-pressurized compartment inside a belly fairing provided in the fuselage, and supplying conditioned air to a pressurized compartment inside the fuselage, a heat source close to the target region of the structural member forming the belly fairing, a conditioned air distribution system in which the conditioned air obtained from the air conditioner by using bleed air from an engine or an auxiliary power unit of the aircraft is discharged outward of the aircraft from the non-pressurized compartment, while the conditioned air is circulated in the pressurized compartment and the non-pressurized compartment, and a heat input reducing system that reduces a heat input to the structural member by using at least the heat blocking material, even under a condition that the heat is radiated from the heat source to the target region and the sunlight is incident on the structural member including the target region.

### Advantageous Effects of Invention

According to the present disclosure, in a part of the airframe, the first color and the second color having a lower light absorption rate than the first color are mixed. In this manner, even when a black color or a dark color having a high light absorption rate is designated as an exterior color of a part of the airframe, the amount of the heat input to the airframe is reduced while an exterior impression of the airframe maintains a designated color. Therefore, it is possible to reduce an increase in an environmental temperature of a compartment inside the airframe.

Furthermore, the reflective material that contributes to an increase in the reflection rate of sunlight is added to the mixed region where the first color and the second color are mixed. In this manner, the increase in the environmental temperature can be more sufficiently reduced by further reducing the amount of the heat input.

### BRIEF DESCRIPTION OF DRAWINGS

FIG. 1A is a schematic view illustrating an interior of an airframe rear part of an aircraft according to an embodiment of the present disclosure. FIG. 1B is a cross-sectional view of the airframe rear part illustrated in FIG. 1A.

FIGS. 2A and 2B are views illustrating an exterior of the aircraft illustrated in FIGS. 1A and 1B. FIG. 2A is a perspective view illustrating the airframe rear part, and FIG. 2B is a top view illustrating the airframe rear part.

FIG. 3 is a schematic view illustrating a range of a mixed region where a black color and a white color are mixed.

FIG. 4 is a sectional view schematically illustrating a mixed region of a structure obtained by using an aircraft manufacturing method according to the embodiment of the present disclosure.

FIGS. 5A and 5B are sectional views of a reference mixed region for describing a procedure for constructing a mixed region by using a first construction method. FIGS. 5C and 5D are views illustrating a transfer roller used for constructing the mixed region.

FIG. 6 is a flow chart illustrating the procedure for constructing the mixed region by using the first construction method.

FIG. 7A is a view illustrating a masking sheet used for constructing a mixed region by using a second construction method, and FIG. 7B is a sectional view illustrating an example of the mixed region constructed by using the second construction method.

FIG. 8 is a flow chart illustrating a procedure for constructing the mixed region by using the second construction method.

FIGS. 9A and 9B are sectional views of a reference mixed region for describing a procedure for constructing a mixed region by using a third construction method.

FIG. 10 is a flow chart illustrating the procedure for constructing the mixed region by using the third construction method.

FIGS. 11A to 11C are sectional views of a reference mixed region for describing a procedure for constructing a mixed region according to a modification example of the third construction method.

FIG. 12 is a flow chart illustrating the procedure for constructing the mixed region according to the modification example of the third construction method.

FIG. 13 is a view for describing another application point of the mixed region.

FIG. 14 is a side view illustrating an example of aircraft according to first to fifth embodiments of the present disclosure.

FIG. 15 is a schematic sectional view of an airframe of the aircraft illustrated in FIG. 14, and illustrates a heat input reducing system for an aircraft.

FIG. 16A is a view illustrating a belly fairing when viewed in a direction of an arrow XVIa in FIG. 15. FIG. 16B is a view illustrating the belly fairing when viewed in a direction of an arrow XVIb in FIG. 15.

FIG. 17 is a schematic sectional view illustrating a heat input reducing structure for an aircraft according to the first embodiment.

FIG. 18 is a schematic sectional view illustrating a heat input reducing structure for an aircraft according to a modification example of the first embodiment.

FIG. 19 is a schematic sectional view illustrating a heat input reducing structure for an aircraft according to the second embodiment.

FIG. 20 is a schematic sectional view illustrating a heat input reducing structure for an aircraft according to a first modification example of the second embodiment.

FIG. 21 is a schematic sectional view illustrating a heat input reducing structure for an aircraft according to a second modification example of the second embodiment.

FIG. 22 is a schematic sectional view illustrating a heat input reducing structure for an aircraft according to the third embodiment.

FIG. 23 is a schematic sectional view illustrating a heat input reducing structure for an aircraft according to the fourth embodiment.

FIG. 24 is a schematic view illustrating an inside of a rear part of a fuselage of an aircraft according to the fifth embodiment.

FIG. 25 is a schematic sectional view taken along line XXV-XXV in FIG. 24.

### DESCRIPTION OF EMBODIMENTS

Hereinafter, embodiments of the present disclosure will be described with reference to the accompanying drawings.

### First Embodiment

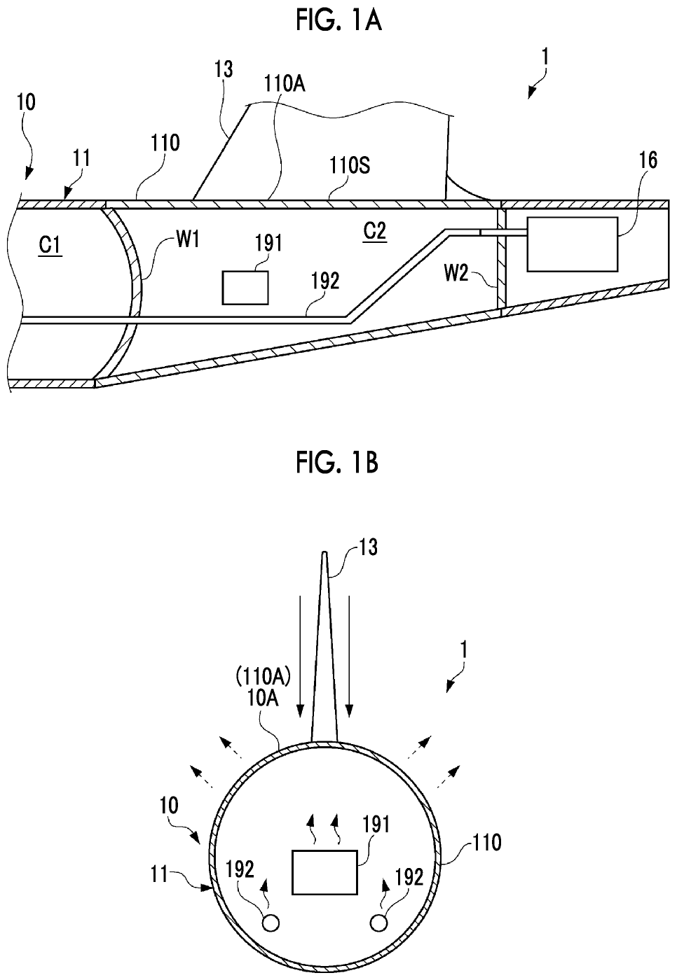

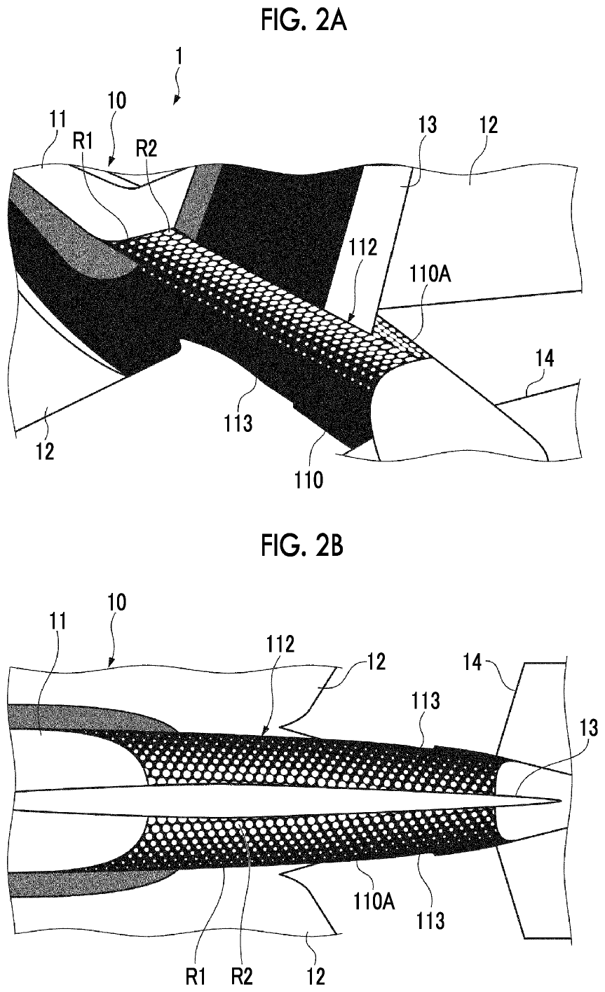

An aircraft 1 illustrated in FIGS. 1A to 2B has an airframe to which a predetermined color distribution pattern is applied. An airframe 10 of the aircraft 1 includes a fuselage 11 having a nose (not illustrated), a main wing 12 (FIGS. 2A and 2B), and a vertical tail 13 and a horizontal tail 14 (FIGS. 2A and 2B) which are provided in a rear part of the fuselage 11. For example, each part of the airframe 10 is formed of a metallic material such as an aluminum alloy, or a fiber reinforced resin material containing a reinforcing fiber such as a glass fiber and a carbon fiber.

The rear part (rear fuselage 110) of the fuselage 11 is formed so that a diameter gradually decreases toward a tail side.

FIG. 1A illustrates an example of an internal structure of the fuselage 11. As illustrated in FIG. 1A, a non-pressurized compartment C2 which is located behind a pressure bulkhead W1 and is not pressurized is formed inside the rear fuselage 110.

The non-pressurized compartment C2 is surrounded by a pressure bulkhead W1, a rear bulkhead (fireproofing wall) W2, and a skin 110S of the rear fuselage 110.

A pressurized compartment C1 pressurized by an air conditioning system (not illustrated) mounted on the aircraft 1 is provided in front of the pressure bulkhead W1. An auxiliary power unit 16 is disposed behind the rear bulkhead W2.

In the non-pressurized compartment C2, an accessory 191 and a bleed air pipe 192 that supplies high-temperature bleed air fetched from the auxiliary power unit 16 to an air conditioning system device (not illustrated) are installed. Heat sources such as the accessory 191 and the bleed air pipe 192 are disposed in the non-pressurized compartment C2. Outward heat discharge from the inside of the non-pressurized compartment C2 relies on heat discharge from the skin 1105 to an outside atmosphere and natural ventilation performed through a vent (not illustrated) by using a pressure difference between the inside and the outside of the non-pressurized compartment C2, and active ventilation inside and outside the non-pressurized compartment C2 (forced ventilation by using an air conditioning system) and temperature control are not performed. Therefore, heat is more likely to stay in the non-pressurized compartment C2, compared to the pressurized compartment C1. Furthermore, the diameter of the non-pressurized compartment C2 is smaller than the diameter of the pressurized compartment C1. Accordingly, heat density of the non-pressurized compartment C2 is more likely to be higher, compared to the pressurized compartment C1 unless some countermeasures against the heat are taken. When the diameter of the fuselage 11 is small to reduce an airframe weight, a volume of the rear fuselage 110 is small. Therefore, the heat density is more likely to be higher.

Incidentally, when the aircraft 1 is parked outdoors, the airframe 10 absorbs radiant energy of sunlight incident on the airframe 10. Accordingly, a temperature of the atmosphere (environmental temperature) inside the airframe 10 increases.

As described above, the heat sources such as the accessory 191 and the bleed air pipe 192 are disposed in the non-pressurized compartment C2, and the active ventilation of the non-pressurized compartment C2 is not performed. Therefore, when the rear fuselage 110 including the non-pressurized compartment C2 and a part of the fuselage 11 including the pressurized compartment C1 are compared with each other, even when solar energy respectively and similarly incident on each part is absorbed in the same manner, the environmental temperature of the non-pressurized compartment C2 is more likely to increase, compared to the environmental temperature of the pressurized compartment C1.

A solid arrow illustrated in FIG. 1B indicates that the sunlight is incident from above in a vertical direction on an upper part 10A of the airframe 10 greatly contributing to the heat input to the airframe 10 due to absorption of light (sunlight). Incident intensity of the upper part 10A is high when the sunlight is substantially vertically incident from above in the vertical direction. Regardless of an orientation of the parked aircraft with respect to a sunbeam, the upper part 10A is less likely to be shaded unlike other parts, and the sunbeam is incident over a daytime while an outside air temperature is high. Therefore, the incident intensity of the upper part 10A is generally higher than the incident intensity of other parts. Therefore, the upper part 10A more greatly contributes to the amount of the heat input caused by light absorption of the upper part 10A, compared to other parts.

According to the above-described fact, when the exterior color of the upper part 10A of the airframe 10 is a dark color having a high light absorption rate, it is disadvantageous from a viewpoint of an increase in an environmental temperature inside the aircraft.

In the present embodiment, the heat input is reduced to reduces the increase in the environmental temperature inside the aircraft for the rear fuselage 110 surrounding the non-pressurized compartment C2 which has a limit to natural ventilation due to heat dissipation to outside air and a pressure difference. Therefore, the present embodiment has a main characteristic with regard to a color applied to an outer surface of the rear fuselage 110.

As an exterior of the rear fuselage 110 is illustrated in FIGS. 2A and 2B, a black color (R1) is applied to a major region of the outer surface of the rear fuselage 110. The black color is also applied to a vertical tail 13 erected from the rear fuselage 110 and a part of the fuselage 11 which is continuous forward from the rear fuselage 110. In addition to the black color, a white color and intermediate colors other than the black color and the white color are applied to the whole airframe 10 including other parts (not illustrated).

In terms of an exterior design of the airframe 10, a color based on the black color is designated as a color of a coating film or a film applied to the outer surface of the rear fuselage 110. A part of the airframe 10 to which the black color is applied has a higher light absorption rate than parts of the airframe 10 to which a light color such as a white color is applied. When the white color is designated for the upper part 110A which greatly contributes to the heat input caused by light absorption, even when the environmental temperature of the non-pressurized compartment C2 is maintained at an allowable or lower temperature, according the present embodiment in which the black color is designated for the rear fuselage 110, it is necessary to design an exterior color to prevent a possibility that the environmental temperature of the non-pressurized compartment C2 including the upper part 110A may exceed the allowable temperature.

In the present embodiment, a color of the upper part of the airframe which greatly contributes to the heat input caused by light absorption is less likely to be noticeable unless the airframe 10 is viewed from above. Based on this fact, the black color and another color having a lower light absorption rate than the black color are mixed in the upper part 110A of the rear fuselage 110. In this manner, while the exterior impression of the entire region of the rear fuselage 110 maintains the black color, the amount of the heat input can be reduced to reduce an increase in the environmental temperature of the non-pressurized compartment C2.

According to the present embodiment, in order to more sufficiently reduce the increase in the environmental temperature, in addition to mixing the white color in the region to which the black color having high light absorption rate is applied, a reflective material that contributes to an increase in a reflection rate of sunlight is added to the region. The reflective material will be described later.

As illustrated in FIGS. 2A and 2B, in the rear fuselage 110, an outer surface of an upper part 110A (hereinafter, referred to as a rear fuselage upper part) includes a mixed region 112 in which a first color R1(black color) having a relatively high light absorption rate and a second color R2 (white color) having a relatively low light absorption rate are mixed. The black color is applied over an entire periphery of the rear fuselage 110 except for the mixed region 112.

Here, without being limited to the black color and the white color, the mixed region 112 can be configured to include a dark color having a relatively large light absorption rate and a light color having a relatively low light absorption rate. A typical example of the dark color is the black color, and a typical example of the light color is the white color. The black color absorbs light over a whole visible light region in a spectrum of light, and the white color irregularly reflects the light over the whole visible light region.

The mixed region 112 is provided on an outer peripheral part of the rear fuselage 110 along a forward-rearward direction on both right and left sides of a base end of the vertical tail 13 erected from the rear fuselage 110.

The mixed region 112 extends over the rear fuselage upper part 110A located in the vicinity of the vertical tail 13 and a predetermined range on both right and left sides of the rear fuselage upper part 110A. In the mixed region 112, the white color and the black color are mixed over a range including the rear fuselage upper part 110A which greatly contributes to the heat input to the rear fuselage 110. The mixed region 112 has a function of reducing the heat input to the rear fuselage 110 by lowering the light absorption rate of in the entire region, compared to a case where only the black color is applied to the same region.

A heat input reducing structure of the aircraft 1 is configured to include the mixed region 112 and a reflective material added to the mixed region 112.

The outer peripheral part of the rear fuselage 110 is configured to include the mixed region 112, a region 113 adjacent to a left side of the mixed region 112 and extending downward, and a region 113 adjacent to a right side of the mixed region 112 and extending downward.

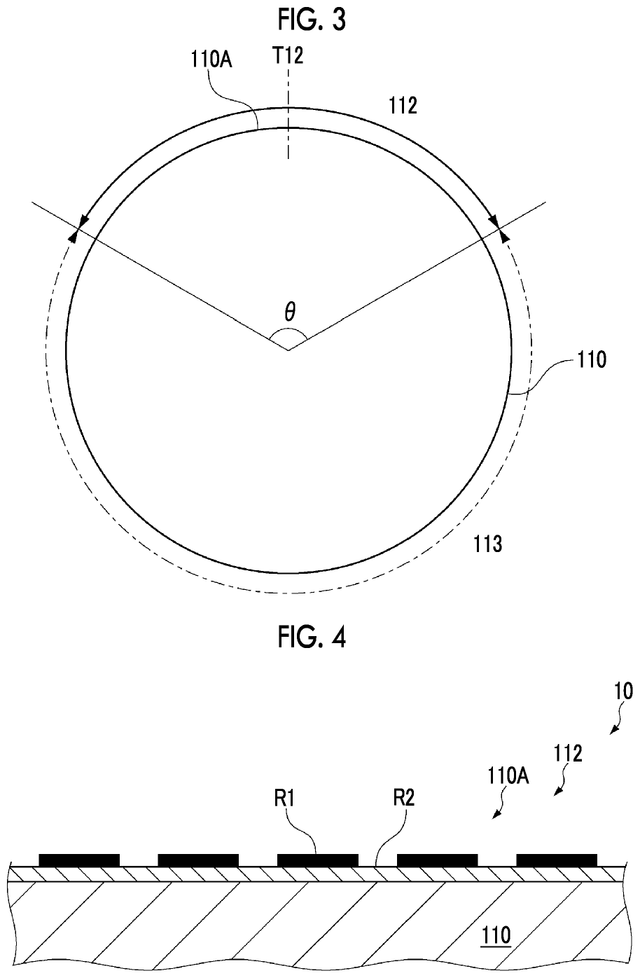

As a circular cross section of the rear fuselage 110 is schematically illustrated in FIG. 3, when an uppermost end position of the mixed region 112 is represented by 12 o'clock (T12) of a timepiece, for example, it is preferable that the mixed region 112 is formed over a range corresponding to 10 o'clock to 2 o'clock. In this case, a central angle θ formed by the mixed region 112 with respect to a center in a cross section of the rear fuselage 110 is 120°. The mixed regions 112 are respectively set over approximately 60° on both sides at a position of the vertical tail 13 which corresponds to 12 o'clock.

In the present specification, the “region” such as the mixed region 112 and the region 113 refers to a part of the airframe 10 which can be recognized separately from the adjacent region, based on colors applied to the regions.

The sunbeam incident from above along the vertical direction is incident over a range of 9 o'clock to 3 o'clock of the outer surface of the rear fuselage 110. When the mixed region 112 is provided over a range from 10 o'clock to 2 o'clock, the light absorption rate is lowered by the mixed region 112 over an entire range where the sunbeam is incident with sufficient incident intensity. Therefore, the amount of the heat input to the rear fuselage 110 can be sufficiently reduced.

Without being limited to the range from 10 o'clock to 2 o'clock, for example, it is preferable that the mixed regions 112 are respectively provided over approximately 30° to 90° on both sides of a position corresponding to 12 o'clock.

when allowable in terms of the exterior design, the mixed region 112 can be set over the entire periphery of the rear fuselage 110. In this case, it is also possible to reduce the heat input caused when the sunbeam irregularly reflected by the ground is incident on the lower part of the rear fuselage 110.

In the mixed region 112, the black color and the white color are mixed in a predetermined area ratio. As illustrated in FIGS. 2A and 2B, a black color part and a white color part in the mixed region 112 form a color distribution pattern in which circular (dot-shaped) color distribution elements are regularly disposed. According to the color distribution pattern, in addition to functionality of reducing the heat input to the rear fuselage 110, the mixed region 112 can also be provided with designability.

The color distribution pattern of the present embodiment is configured to include a lot of white circles (dots) arrayed at a constant pitch. A diameter of the white circle gradually increases upward from below. As a result, an area ratio of a black background which is a white circular background decreases.

For example, the light absorption rate of the black color part is 0.95, and for example, the light absorption rate of the white part is 0.3. The light absorption rate of the whole mixed region 112 depends on the area ratio between the black color part and the white color part of the mixed region 112. Therefore, the area ratio decreases, compared to a case where only the black color is applied to the same region. For example, when the area ratios of the black color and the white color are equal (1:1), the light absorption rate of the whole mixed region 112 is 0.625.

In addition to the black color and the white color, a third color different from the black color and the white color (for example, an intermediate color such as a red color, a blue color, and a gray color) may be mixed in the mixed region 112. Even in this case, the whole mixed region 112 is provided with the light absorption rate corresponding to the area ratio of each color. As long as at least two colors are mixed, any number of colors applied to the mixed region 112 may be used.

Without being limited to the circular shape, a color distribution pattern including color distribution elements having other basic shapes such as a rectangular shape, a stripe shape, and a grid shape can be adopted in the mixed region 112. Here, the color distribution elements do not necessarily have to be regularly disposed, and may be randomly (irregularly) disposed.

In a lower end of the mixed region 112 adjacent to the region 113, the area ratio occupied by the white color part is low. On the other hand, in an upper end of the mixed region 112 (in the vicinity of the vertical tail 13), the area ratio occupied by the white color part is high. In the mixed region 112, the area ratio occupied by the white color gradually increases upward from below. In other words, the light absorption rate gradually decreases upward from below. Therefore, as the part more greatly contributes to the heat input to the rear fuselage 110, and as the part is more likely to be relatively visible in the mixed region 112 while the light absorption rate is lowered, the area ratio of the black color can be increased to ensure the designability of the airframe 10.

The upper part 110A is not noticeable since the airframe 10 is laterally observed at an airport or at a maintenance site when the aircraft is parked or during takeoff and landing, or since the lower part of the airframe 10 is observed from below. Therefore, even when the upper part 110A has the higher area ratio of the white color than the area ratio of the black color, the heat input to the rear fuselage 110 can be reduced without significantly affecting the exterior impression of the airframe 10 which is given to a viewer. In an upper end portion of the mixed region 112, the area ratio of the white color may be 100%.

On the other hand, the region 113 is easily noticeable, and is often viewed. Accordingly, the region 113 of the rear fuselage 110 which greatly affects the exterior impression maintains the black color. In the lower end of the mixed region 112 adjacent to the region 113, the area ratio occupied by the black color part is high. That is, a color density difference between the region 113 and the lower end of the mixed region 112 is small. Accordingly, a boundary between the mixed region 112 and the region 113 is not noticeable, and the mixed region 112 and the region 113 can be continuously formed to realize a totally harmonious design in the rear fuselage 110.

Now, the reflective material added to the mixed region 112 of the present embodiment will be described. The reflective material is added to at least a black color-applied part in the mixed region 112. The reflective material contributes to an increase in a reflection rate of sunlight. Accordingly, the reflective material is contained as a fine particle in a part of a coating film or an exterior film applied to the rear fuselage 110.

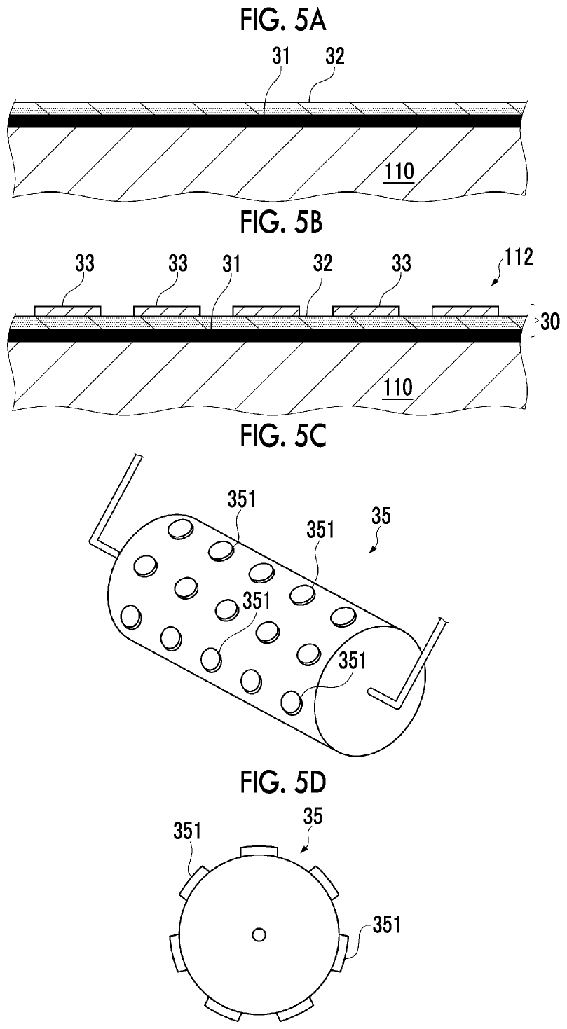

An example of a structure including the reflective material will be described with reference to FIG. 5B. FIG. 5B illustrates a coating film structure 30 including the mixed region 112 obtained by coating. The coating film structure 30 includes a black color coating film 31 containing a black color pigment (colorant) and applied to the outer surface of the rear fuselage upper part 110A, a reflective coating film 32 containing the reflective material, and a white color coating film 33 containing a white color pigment (colorant).

In this example, the black color coating film 31 is napplied over an entire region of the mixed region 112. The reflective coating film 32 is applied over an entire region of the black color coating film 31. The reflective coating film 32 increases the reflection rate of sunlight in the black color part of the mixed region 112 while the black color of the black color coating film 31 is expressed. Due to the presence of the reflective coating film 32, the light absorption rate in the black color part in the mixed region 112 is lowered, compared to a case where the reflective coating film 32 is not applied. Therefore, the amount of the heat input caused by light absorption decreases in the mixed region 112 as a whole.

The reflective coating film 32 can be applied by using a coating material obtained by dispersing the reflective material in an appropriate dispersion medium. As the coating material, a coating material called a solar reflection paint (SRP) can be used. For example, the coating material can include “CA8800 SR Solar Reflective Topcoat” of DESOTHAE (registered trademark) manufactured by PPG Industries, Inc. of the United States. According to the coating material, the light reflection rate can be increased to lower the light absorption rate mainly by using reflection in a near-infrared region in a radiation spectrum of the sunlight.

In the visible light region, the light reflection rate is limited by color selection of an outer surface of an object. Therefore, in the visible light region, even though the light reflection rate can be increased by increasing the area ratio occupied by the white color, the white color cannot be applied to the whole mixed region 112 in terms of the exterior design of the rear fuselage 110. Therefore, in the mixed region 112, in addition to mixing the white color with the black color, the reflective material that reflects the light in the near-infrared region is used. In this manner, the light reflection rate is further increased while a required exterior design is maintained. Therefore, it is possible to further sufficiently reduce the amount of the heat input caused by the light absorption.

In addition, for example, the reflective coating film 32 can be applied by using a coating material containing an inorganic hollow filler. As the hollow filler, there exists a heat blocking coating material using a spherical hollow body (shirasu balloon or glass balloon) formed of shirasu containing aluminosilicate glass as a main component or glass containing soda lime borosilicate glass as a main component. The inorganic hollow bodies mainly reflect light the in the near-infrared region having a wavelength of 780 nm or longer, and contain air. Accordingly, thermal conduction can be reduced. Therefore, the inorganic hollow bodies can contribute to heat input reducing. For example, an average particle size of the inorganic hollow body is approximately 65 μm, and for example, bulk specific gravity is approximately 0.075. In addition, for example, a volume content of the inorganic hollow body coating material is approximately 20% to approximately 50%.

As described above, according to the rear fuselage 110 including the mixed region 112 in which the white color is mixed with the black color and the reflective material is added to at least the black color part, the amount of the heat input caused by the absorption of the sunlight is reduced. Therefore, it is possible to sufficiently reduce an increase in the environmental temperature of the non-pressurized compartment C2 inside the rear fuselage 110.

In addition, since the amount of the heat input to the rear fuselage 110 is reduced, it is possible to reduce an increase in not only the environmental temperature of the non-pressurized compartment C2 but also the temperature of the member of the rear fuselage 110 including the non-pressurized compartment C2. Therefore, a fiber reinforced resin having lower heat resistance than an aluminum alloy can be adopted for the member (skin or stringer) of the rear fuselage 110.

Even when an exterior film containing the reflective material applied to at least the black color part and increasing the reflection rate of sunlight is provided in the rear fuselage 110, an advantageous effect similar to that obtained when a coating film containing the reflective coating film 32 is applied can be obtained.

A location of the airframe 10 in which the mixed region 112 is provided is not limited to the rear fuselage 110, and may be any location where heat staying can be a problem in the airframe 10.

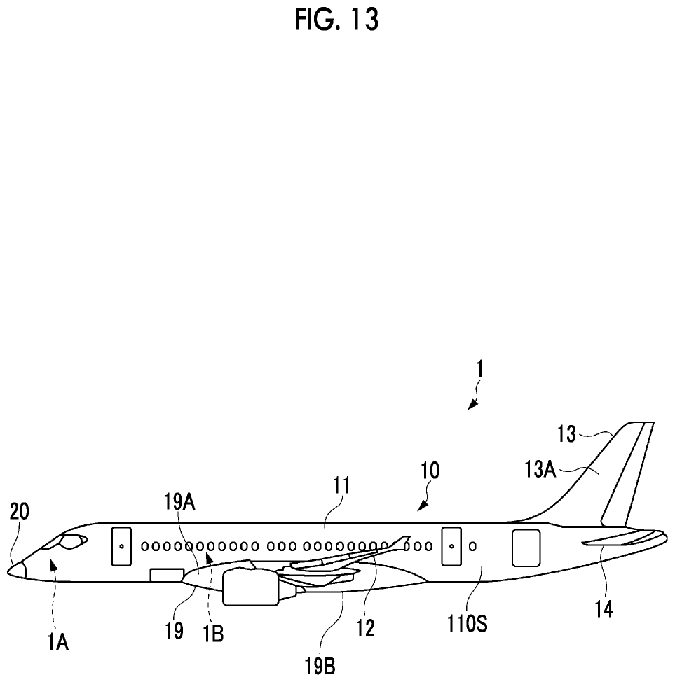

For example, the mixed region 112 may be provided on a side surface 19A of a belly fairing 19 (belly fairing) provided on the lower side of the fuselage 11 and illustrated in FIG. 13. The belly fairing 19 covers a lower part 19B of the fuselage 11 from below. A part between the belly fairing 19 and the lower part 19B of the fuselage 11 corresponds to a non-pressurized compartment where temperature control is not performed although forced ventilation is performed. An air conditioning unit serving as a heat source is typically disposed in the compartment.

The sunlight is laterally incident on the belly fairing 19 during a morning time zone including sunrise and an evening time zone including sunset. It is preferable to provide the mixed region 112 over at least a range corresponding to the side surface 19A on the outer surface of the belly fairing 19 so that the inside of the compartment or the belly fairing 19 does not exceed an allowable temperature due to solar radiation on the belly fairing 19. Here, a lower surface of the belly fairing 19 has a smaller amount of the heat input caused by the solar radiation when parked, compared to the side surface 19A. Therefore, a single dark color can be applied.

Even when the belly fairing 19 is formed of the fiber reinforced resin, the amount of the heat input is reduced by the mixed region 112. In this manner, the belly fairing 19 maintains the allowable temperature. That is, construction of the mixed region 112 on a member using the fiber reinforced resin significantly reduces the heat input.

Alternatively, the mixed region 112 may be provided in the vertical tail 13 (FIG. 13). The vertical tail 13 is formed of the fiber reinforced resin or an aluminum alloy.

As in the belly fairing 19, the vertical tail 13 also laterally receives a large amount of the heat input caused by the solar radiation during morning and evening time zones. Therefore, it is preferable to provide the mixed region 112 over a range corresponding to at least the side surface 13A on the outer surface of the vertical tail 13. An interior of the vertical tail 13 corresponds to the non-pressurized compartment in which neither forced ventilation nor temperature control is performed by the air conditioning system. Since the mixed region 112 is provided in the vertical tail 13, accessories disposed inside the vertical tail 13 can be protected from the heat, and members of the vertical tail 13 can maintain the allowable temperature.

Alternatively, the mixed region 112 may be entirely or partially provided on the outer surface of a radome 20 (FIG. 13) located in the front end of the fuselage 11. An interior of the radome 20 also corresponds to the non-pressurized compartment in which neither forced ventilation nor temperature control is performed by the air conditioning system.

When the mixed region 112 is provided on the side surface 19A of the belly fairing 19, the side surface 13A of the vertical tail 13, and the radome 20, for example, a monochrome dot-shaped color distribution pattern similar to the color distribution pattern of the rear fuselage upper part 110A illustrated in FIGS. 2A and 2B can be adopted.

Furthermore, without being limited to the non-pressurized compartment, the mixed region 112 may be provided in a member such as a skin forming a pressurized compartment.

For example, a space between a liner (not illustrated) forming an inner wall of a cabin 1B or a cockpit 1A inside the fuselage 11 and the skin (outer skin) is included in the pressurized compartment C1, and is pressurized by the air conditioning system. However, the space is a narrow compartment separated by the liner from an interior space of the cabin 1B or the cockpit 1A, and the forced ventilation or the temperature control is not typically performed on the space by the air conditioning system. Moreover, accessories serving as heat sources are typically disposed in the space. In this case, even when a designated color of the skin including the space is a dark color, it is preferable to provide the mixed region 112 over a predetermined range of the skin so that the temperature of the space, the skin, or a stringer does not exceed the allowable temperature due to the solar radiation on the skin. As in a case of the rear fuselage 110, it is preferable that a range provided with the mixed region 112 includes an upper part of a region in which the dark color is designated on the skin. However, as long as a configuration is allowable in terms of the exterior design and the amount of the heat input to the space, the skin, or the stringer can be reduced to the allowable temperature, it is also allowable to provide the mixed region 112 only in the side surface part of the skin.

Hereinafter, an example of a method for manufacturing the aircraft 1 in which the mixed region 112 is included in the airframe 10 will be described.

The above-described reflective material may not be added to a coating film structure or a film structure provided with the mixed region 112 according to a construction procedure described below. FIG. 4 illustrates a part of the airframe 10 (rear fuselage upper part 110A) provided with the mixed region 112 to which the reflective material is not added. When the outer surface of the airframe 10 is observed, the black color (R1) and the white color (R2) are expressed in the mixed region 112. The reflective material can be added to the mixed region 112 when necessary.

As illustrated in FIG. 4, applying the white color (R2) as a base to the outer surface of the airframe 10 and applying the black color (R1) thereto are more preferable than a reverse procedure, that is, applying the black color as the base and applying the white color thereto. In a former case, a part of the sunlight transmitted through the black color (R1) part is reflected by the white color (R2) part. Therefore, the amount of the heat input to the airframe 10 can be reduced.

With reference to FIGS. 5A to 5D and the subsequent drawings, each method of constructing the mixed region 112 to which the reflective material is added will be described. In the following description, a procedure of adding the reflective material is omitted. In this manner, it is possible to obtain a structure including the mixed region 112 to which the reflective material is not added.

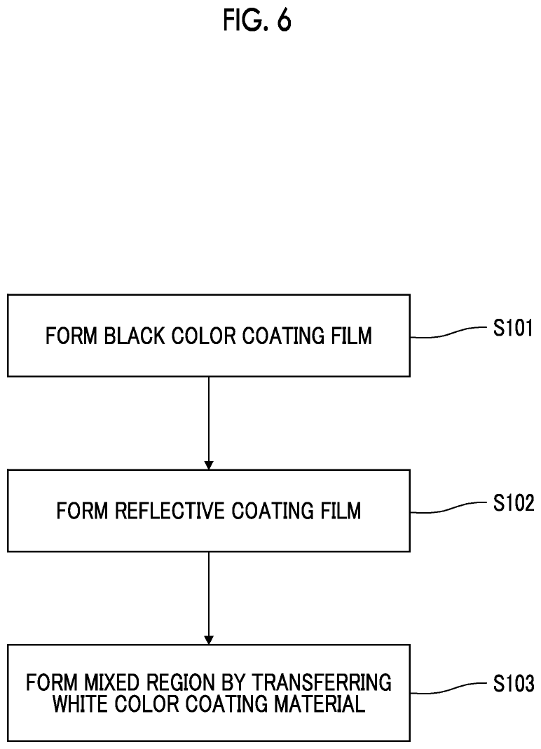

First, with reference to FIGS. 5A to 6, a first method of manufacturing the aircraft 1 after coating the airframe 10 will be described.

[First Construction Method Relating to Coating]

FIG. 6 illustrates Steps S101 to S103 relating to a coating procedure for obtaining the coating film structure 30 illustrated in FIG. 5B.

In forming the black color coating film 31 (Step S101), a coating material obtained by dispersing a black color pigment (colorant) in an appropriate dispersion medium is dipped over an entire region in a predetermined range on the outer surface of the rear fuselage 110, and the black color coating film 31 by using an appropriate method such as coating using a roller or a spray gun. When the coating material is dried and cured, the black color coating film 31 is formed on the outer surface of the rear fuselage 110.

Subsequently, when the reflective coating film 32 is required, a heat blocking coating material containing the above-described SRP or glass balloon is constructed in the black color coating film 31 by using a dipping or coating method, and the coating material is dried and cured. In this manner, as illustrated in FIG. 5A, the reflective coating film 32 laminated on the black color coating film 31 can be formed (Step S102).

Furthermore, the coating material obtained by dispersing a white color pigment (colorant) in the appropriate dispersion medium is constructed in a predetermined location on the reflective coating film 32(or on the black color coating film 31 when the reflective coating film 32 does not exist). In this manner, the mixed region 112 in which the white color and the black color are mixed is obtained (Step S103).

The construction is limited to the predetermined location. Accordingly, for example, a transfer roller 35 as illustrated in FIGS. 5C and 5D can be used. An outer peripheral part of the roller 35 includes a plurality of dot-shaped pads 351 corresponding to the white color part in the color distribution pattern. When the white color coating material is transferred to the reflective coating film 32(or the black color coating film 31) by using the roller 35 and the white color coating film 33 is formed after drying the coating material, the black color coating film 31 and the white color coating film 33 partially laminated on the black color coating film 31 can be used to obtain the mixed region 112 in which the black color part and the white color part are mixed.

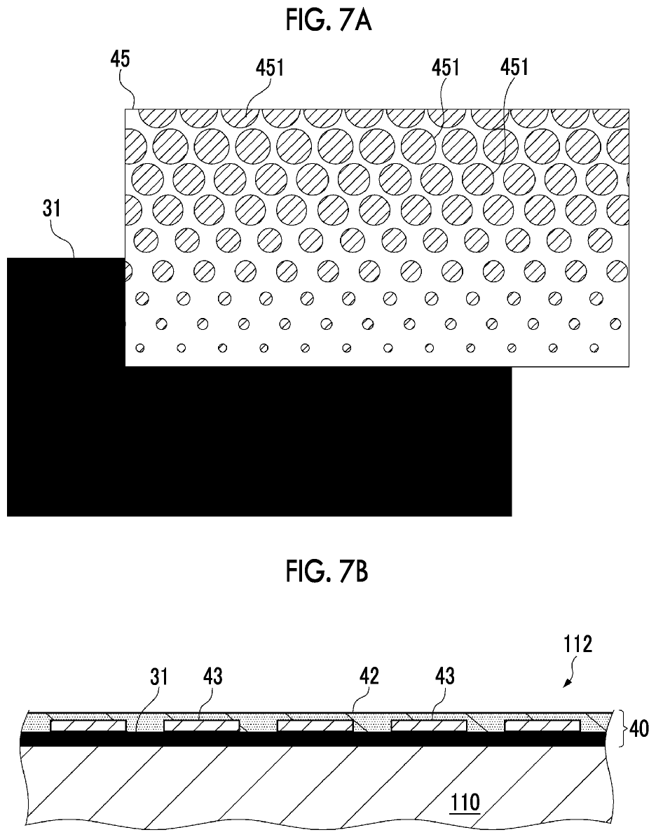

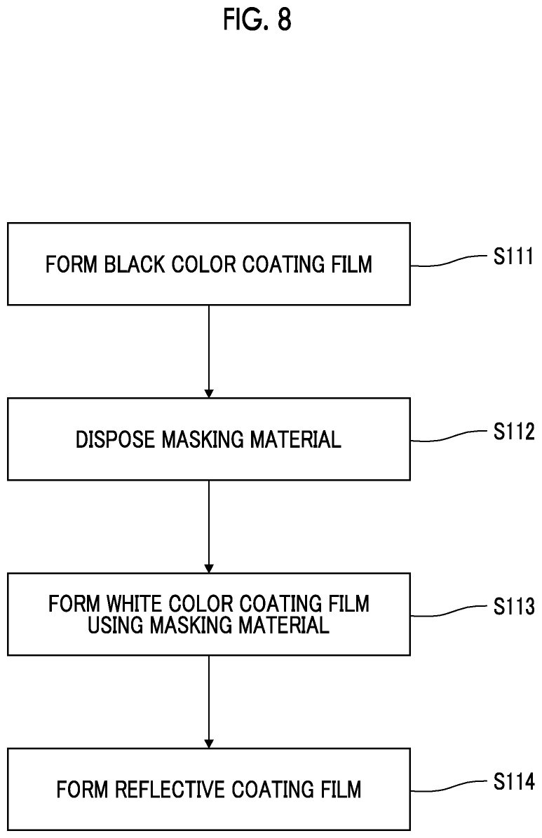

Next, with reference to FIGS. 7A to 8, a second method of manufacturing the aircraft 1 after coating the airframe 10 will be described.

[Second Construction Method Relating to Coating]

In the second construction method, instead of using the roller 35 described above, a masking sheet 45 (FIG. 7A) is used.

FIG. 8 illustrates Steps S111 to S114 relating to a coating procedure for obtaining the coating film structure 40 illustrated in FIG. 7B.

The black color coating film 31(Step S111) can be formed in the same manner as in Step S101 of forming the black color coating film of the first construction method described above.

When the black color coating film 31 is formed on the outer surface of the rear fuselage 110, a required location of the black color coating film 31 is masked by disposing a masking sheet 45 on the outer surface of the black color coating film 31(Step S112). The masking sheet 45 has a plurality of dot-shaped through-holes 451 (illustrated with diagonal lines in FIG. 7A) corresponding to the white color part in the color distribution pattern.

Subsequently, the coating material obtained by dispersing the white color pigment (colorant) in the appropriate dispersion medium is applied to the black color coating film 31 in a masked state by using the roller or the spray gun, and the coating material is dried and cured, thereby obtaining the white color coating film 43 (Step S113). The white color coating material does not adhere to a location of the black color coating film 31 covered with the masking sheet 45. Accordingly, the white coating material adheres to a limited location of the through-hole 451. When the masking sheet 45 is removed, the black color coating film 31 and the white color coating film 43 partially laminated on the black color coating film 31 are used so that the mixed region 112 in which the black color part and the white color part are mixed can be obtained on the outer surface of the rear fuselage 110.

Furthermore, when the reflective coating film 42 is required, the above-described SRP or heat blocking coating material containing the glass balloon is constructed in the black color coating film 31 and the white color coating film 43 by using a dipping or coating method, and the coating material is dried and cured. In this manner, as illustrated in FIG. 7B, the reflective coating film 42 coated with the black color coating film 31 and the white color coating film 43 can be formed (Step S114).

The reflective coating film 42 may be added to at least the black color part in the mixed region 112, and may not be added to the white color part. Therefore, when a thickness of the reflective coating film 42 from a surface of the black color coating film 31 is thin, a surface layer of the white color coating film 43 may be exposed from the reflective coating film 42.

As in the first construction method described above, the reflective coating film 42 can also be provided in the black color coating film 31 before the white color coating film 43 is formed.

A third construction method described below uses an exterior film constructed over a predetermined range including the rear fuselage upper part 110A on the outer surface of the airframe 10.

The exterior film is mounted on the airframe 10 to cover the surface of the airframe, and is called a so-called wrapping film. The exterior film is provided with the mixed region 112. The exterior film can also be entirely or partially provided on the outer surface of the coated airframe 10.

Although the exterior film is fixed to the airframe 10 not to be delaminated during flight, the exterior film is easily delaminated from the airframe 10 when removed. Accordingly, the exterior film can be easily replaced with another exterior film.

Therefore, the environmental temperature can be tested by changing the color distribution pattern of the mixed region 112 provided in the exterior film in various ways. Based on test results, it is possible to adopt the color distribution pattern having a high heat input reducing effect. The rear fuselage upper part 110A may be coated in accordance with the color distribution pattern determined by using the exterior film.

The exterior film can be constructed at a lower cost and in a shorter period of time, compared to coating, and is suitable for construction in the airframe 10 of the existing aircraft. That is, the exterior film enables not only the newly manufactured aircraft 1 but also the existing aircraft to be provided with the heat input reducing effect.

It is desirable that the exterior film is constructed behind a suction port of an engine.

[Third Construction Method Relating to Film]

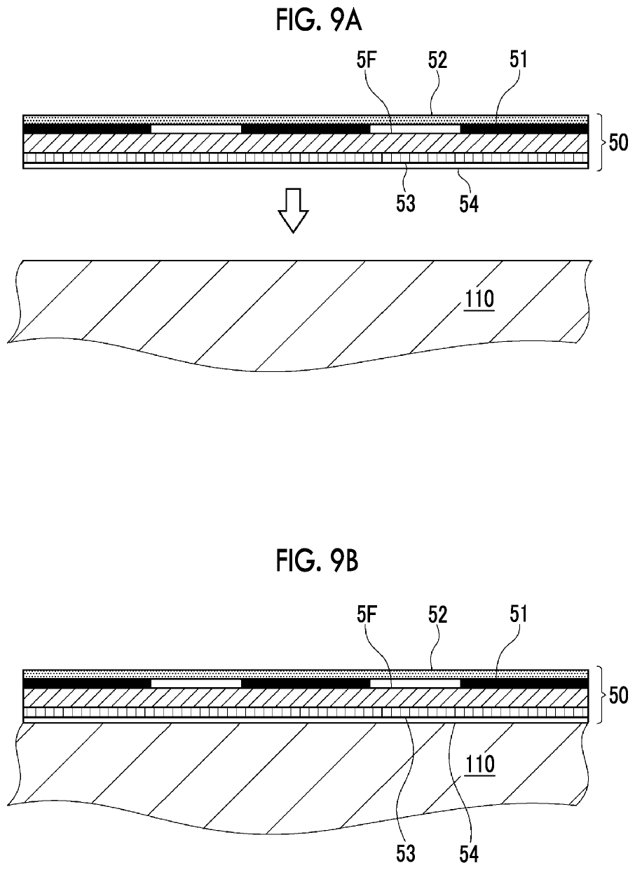

FIG. 9A illustrates an example of a configuration of an exterior film 50. The exterior film 50 includes a white color film preform 5F formed of a resin material, an ink layer 51 and a reflective layer 52 which are laminated on a surface of the film preform 5F and formed of black color ink, and an adhesive layer 53 provided on a back surface of the film preform 5F. The film preform 5F may be the black color, the ink layer 51 may be formed of white color ink, the film preform 5F may be a transparent color, and the ink layer 51 may be formed of the white color ink and the black color ink.

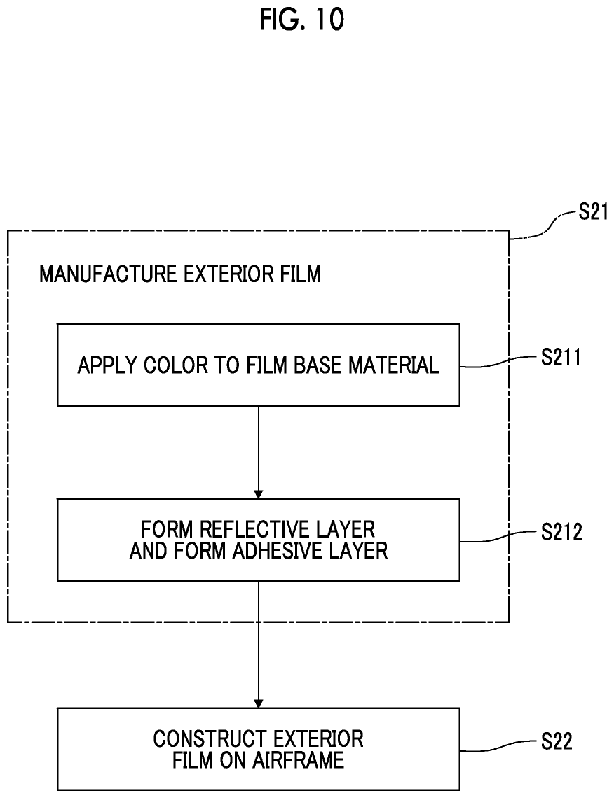

For example, the exterior film 50 can be manufactured by using a method described below (Step S21 in FIG. 10). A predetermined range of the airframe 10 can be covered with the exterior film 50 (Step S22 in FIG. 10) so that the mixed region 112 is provided on the outer surface of the airframe 10.

First, the black color is applied to one surface side of the white color film preform 5F illustrated in FIG. 9A by means of printing using the black color ink (colorant) (Step S211). In this manner, the black color and the white color are mixed in a predetermined color distribution pattern on the film preform 5F.

In subsequent Step S212, the reflective layer 52 formed by dispersing a reflective material in a dispersion medium is provided on the ink layer 51 formed of the black color ink, when necessary. Furthermore, the adhesive layer 53 containing an adhesive is provided on the other surface side of the film preform 5F (hitherto, Step S212). The adhesive layer 53 is covered with a release paper 54 which can be delaminated until immediately before the adhesive layer 53 is constructed in the airframe 10.

The reflective layer 52 may be provided at a location to which at least the black color is applied. For example, the reflective layer 52 can be provided by means of printing.

When the exterior film 50 is manufactured after Steps S211 and S212 described above, the exterior film 50 is positioned and constructed in the airframe 10 (rear fuselage 110) (Step S22). The exterior film 50 is held on the outer surface of the rear fuselage 110 by the adhesive layer 53.

[Modification Example of Third Construction Method Relating to Film]

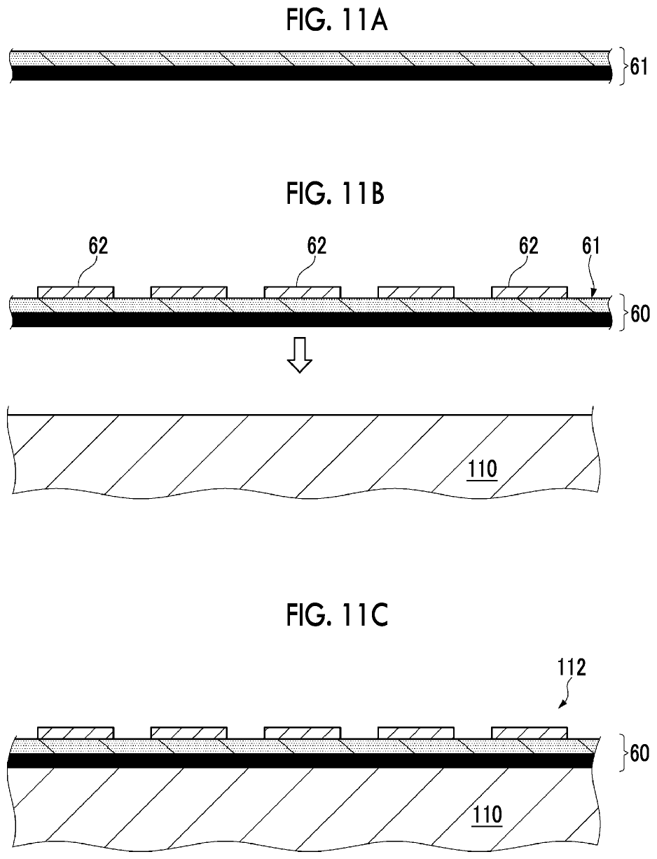

Next, a construction example of the exterior film 60 (FIG. 11B) will be described.

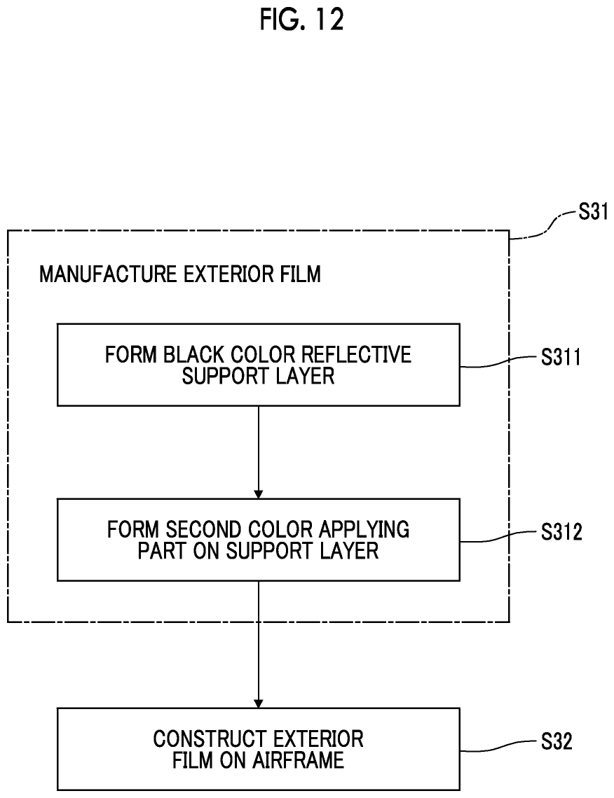

First, as illustrated in FIG. 11A, a support layer 61 formed by dispersing a black color colorant in a dispersion medium is formed (Step S311 in FIG. 12). Here, when the support layer 61 is formed, in addition to the black color colorant, the reflective material is dispersed in the dispersion medium to form the black color reflective support layer 61 having a function of increasing the reflection rate of sunlight.

Next, a white color applying part 62 formed by dispersing the white color colorant in the dispersion medium is provided on the black color reflective support layer 61 so that the black color and the white color are mixed in a predetermined color distribution pattern (Step S312 in FIG. 12). An adhesive layer (not illustrated) is provided on a back side of the black color reflective support layer 61.

When the exterior film 60 is manufactured after Steps S311 and S312 described above, the exterior film 60 is positioned and constructed in the airframe 10 (rear fuselage 110) (Step S32 in FIG. 12).

The construction method described above is merely an example.

In addition, for example, a film containing the reflective material can be mounted on the mixed region 112 configured to serve as the coating film and having the black color and the white color, or the coating material containing the reflective material can be provided on the surface of the exterior film to which the black color and the white color are applied.

Incidentally, for example, in some cases, in the non-pressurized compartment of the aircraft, there may exist a heat source such as a pipe through which high-temperature and high-pressure bleed air flows from an engine or an auxiliary power unit. Due to radiation of the heat from the internal heat source and solar radiation from the outside, even when the non-pressurized compartment is ventilated, there is a possibility that a temperature of a structural member forming the non-pressurized compartment may be affected.

Therefore, the present invention provides the heat input reducing structure for the aircraft and the heat input reducing system which can sufficiently protect the structural member from the heat, even when the heat source has to be disposed close to the structural member forming the non-pressurized compartment due to restrictions such as a large number of pipes including bleed air pipes and hydraulic system pipes and mounting spaces of accessories.

Hereinafter, first to fifth embodiments will be described with reference to the accompanying drawings.

First, items common to the respective embodiments will be described.

[Schematic Configuration of Aircraft]

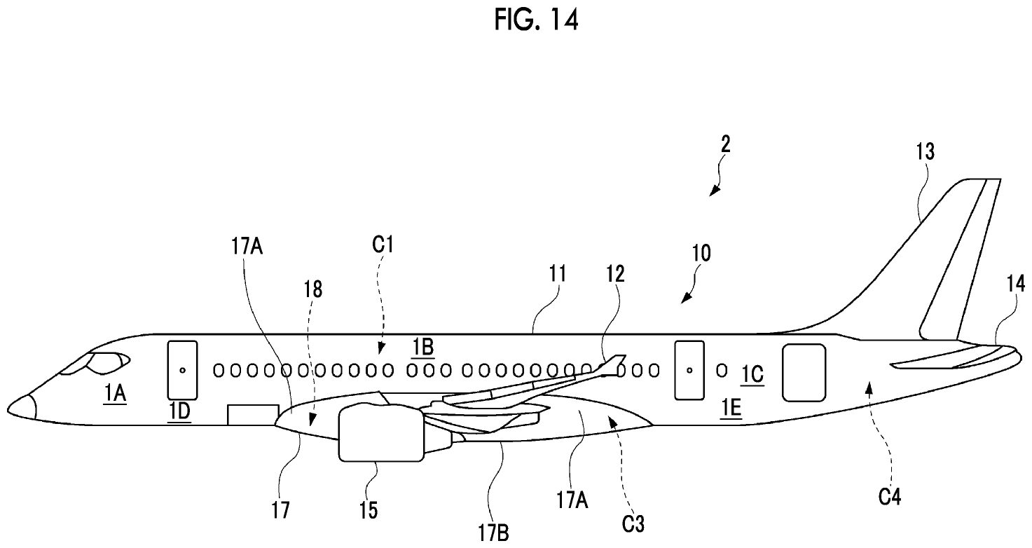

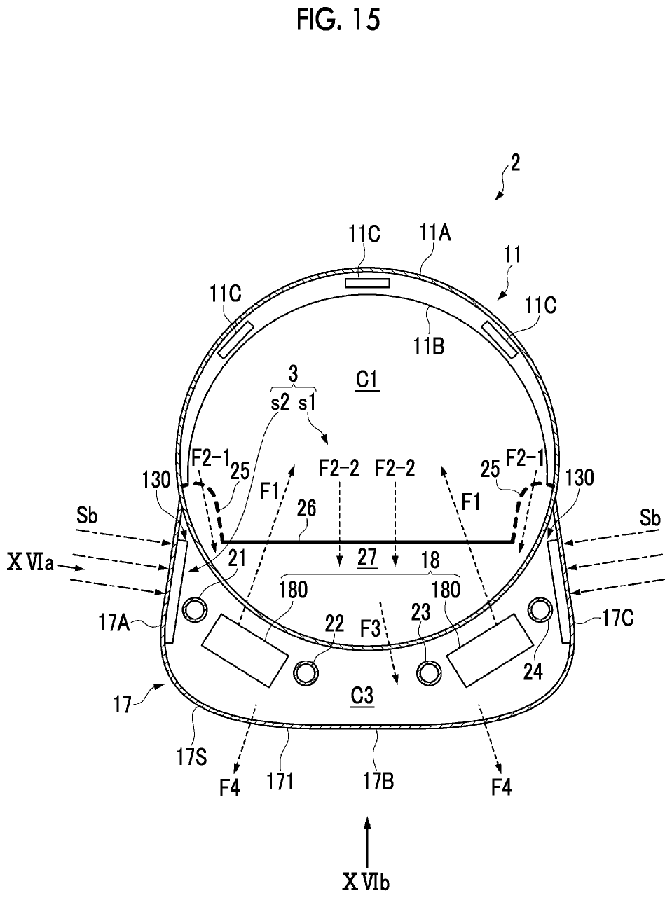

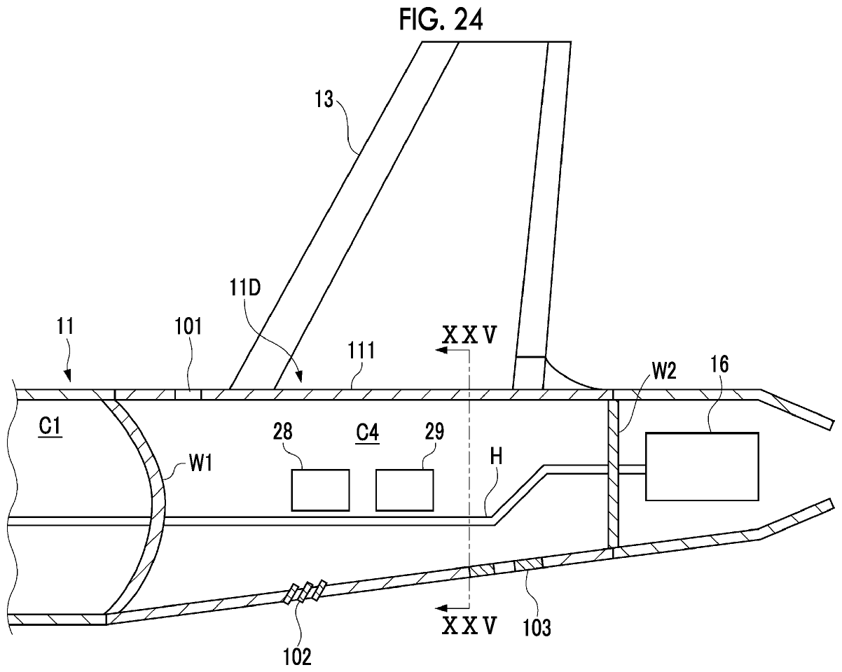

An aircraft 2 illustrated in FIG. 14 includes the fuselage 11, a main wing 12, the vertical tail 13, the horizontal tail 14, an engine 15 supported by the main wing 12, the auxiliary power unit 16 (FIG. 24) accommodated in the rear part of the fuselage 11, a belly fairing 17 (belly fairing) covering a predetermined range in the lower part of the fuselage 11, and an air conditioning system 18 including an air conditioner 180 (FIG. 15).

The aircraft 2 includes the pressurized compartment C1 including the cockpit 1A (cockpit), the cabin 1B (cabin), a cargo compartment 1C (cargo), and electronic device storage spaces 1D and 1E, and the non-pressurized compartments C3 and C4 which are not pressurized.

The air conditioning system 18 mounted on the aircraft 2 performs pressurization, temperature and humidity adjustment, and ventilation on the pressurized compartment C1.

The non-pressurized compartment C3 corresponds to a compartment between the belly fairing 17 and the lower part of the fuselage 11. The non-pressurized compartment C4 corresponds to a compartment on the tails 13 and 14 sides from the pressure bulkhead W1 in FIG. 24 in the fuselage 11.

[Air Conditioning System]

The air conditioning system 18 is configured to include a pair of air conditioners 180 (FIG. 15) which can obtain air conditioning air by using bleed air obtained from the engine 15 or the auxiliary power unit 16 as a pressure source and a heat source, a supply duct (not illustrated) which supplies the conditioned air obtained from the air conditioners 180 to the pressurized compartment C1, and a discharge duct (not illustrated) which discharges the air in the pressurized compartment C1 to the non-pressurized compartment C3. The air conditioning system 18 is referred to as an environmental control system (ECS).

The air conditioners 180 are respectively provided on a port side and a starboard side of the lower part of the fuselage 11. Each of the air conditioners 180 includes a compressor, a heat exchanger, and an expansion valve.

Each of the air conditioners 180 obtains the air conditioning air by using the bleed air introduced from the engine 15 during flight and outside air introduced from the outside of the aircraft. While the aircraft is parked, the bleed air introduced from the auxiliary power unit 16 is used instead of the bleed air from the engine 15. The bleed air pipes through which the bleed air flows are respectively routed from the engine 15 or the auxiliary power unit 16 to the inside of the belly fairing 17 covering the air conditioner 180.

As illustrated in FIG. 15, the belly fairing 17 includes a port side wall 17A, a lower wall 17B, and a starboard side wall 17C, and shows a substantially U-shaped cross section.

Although not specifically illustrated, a plurality of bleed air pipes, a plurality of hydraulic pipes through which hydraulic oil of a hydraulic system flows, various accessories, and electric wires are disposed inside the belly fairing 17. FIG. 15 illustrates a plurality of pipes 21 to 24 as representatives of some of the bleed air pipes and the hydraulic pipes which are provided in the mounting space inside the belly fairing 17.

[Exterior of Belly Fairing]

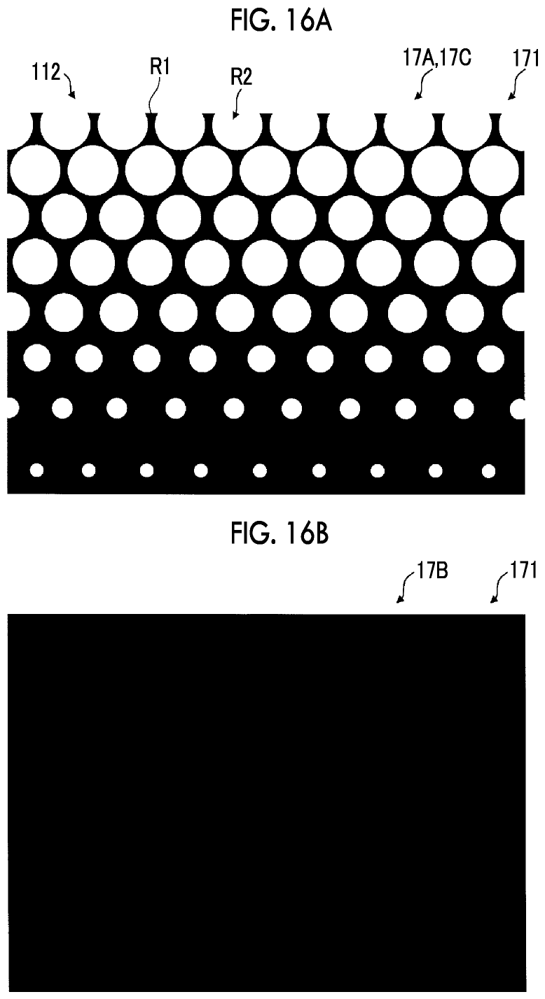

As illustrated in FIG. 16A, it is preferable that the belly fairing 17 includes the mixed region 112 having the color distribution pattern in which a first color R1 (for example, the black color) and a second color R2 (for example, the white color) are mixed on the outer surface of the side walls 17A and 17C. The mixed region 112 extends over a predetermined range on each of the side walls 17A and 17C of the belly fairing 17. Depending on a time zone, the sunlight is directly incident on the side walls 17A and 17C of the belly fairing 17. In this case, it is preferable that the mixed region 112 is provided in the belly fairing 17 over a range where incident intensity of the sunlight is relatively high. As illustrated in FIG. 16B, the black color similar to the color applied to the fuselage 11 is applied the lower wall 17B adjacent to the mixed region 112, and the color of the lower wall 17B is similar to the first color R1 in the mixed region 112.

In an example illustrated in FIG. 16A, a ratio of the second color R2 to a ratio of the first color R1 per unit area gradually increases toward the lower wall 17B from the upper part of each of the side walls 17A and 17C, but the configuration is not limited thereto. An area ratio between the first color R1 and the second color R2 can be appropriately set in view of the heat input to a structural member 171 of the belly fairing 17 which depends on the incident intensity of the sunlight.

In addition, in view of the heat input caused when the sunbeam irregularly reflected on the ground is incident on the lower wall 17B, the mixed region 112 may be provided on the lower wall 17B.

As in the above-described embodiment, it is preferable that the reflective material which contributes to an increase in the reflection rate of sunlight is added to at least the part of the first color R1 in the mixed region 112. The reflective material contributes to the increase in the reflection rate of sunlight. Accordingly, the reflective material is contained as a fine particle in a part of the coating film or the exterior film used for constructing the mixed region 112. In addition to mixing the second color R2 with the first color R1 on the outer surface of the structural member 171, the reflective material that reflects the light in the near-infrared region is used. In this manner, while a required exterior design is maintained, it is possible to more sufficiently reduce the amount of the heat input to the structural member 171 which is caused by the light absorption.

[Conditioned Air Distribution System]

With reference to FIG. 15, an example of a system s1 in which the conditioned air flows through the aircraft by the air conditioning system 18 will be described.

While the conditioned air distribution system s1 circulates the conditioned air obtained by the air conditioner 180 to the pressurized compartment C1 and the non-pressurized compartment C3, the conditioned air distribution system s1 discharges the conditioned air outward of the aircraft from the non-pressurized compartment C3. An arrow F1 in FIG. 15 indicates a flow of the conditioned air supplied from the air conditioner 180 to the cockpit 1A and the cabin 1B through a supply duct (not illustrated).

FIG. 15 illustrates a cross section of the cabin 1B. The inside of a skin 11A of the fuselage 11 corresponds to the pressurized compartment C1. In addition to an accessory 11C installed between the skin 11A and a liner 11B, an accessory (not illustrated) is also installed inside a dado panel 25.

As illustrated by an arrow F2-1, the conditioned air supplied to the cabin 1B is supplied to a cabin underfloor space 27 through a path penetrating the dado panel 25 and a floor 26, and contributes to cooling the accessory installed in the cabin underfloor space 27. In addition, the conditioned air supplied to the cockpit 1A and the cabin 1B flows out to the underfloor space through a path penetrating the floor 26 forward or rearward of the airframe, and also contributes to cooling the accessory installed in the electronic device storage spaces 1D and 1E. (refer to F2-2). The conditioned air directed rearward (tails 13 and 14 sides) from the cabin 1B is supplied to the electronic device storage spaces 1D and 1E via the cargo compartment 1C.

The air in the cabin underfloor space 27 is supplied to the non-pressurized compartment C3 inside the belly fairing 17 through a pressure regulating valve (outflow valve, not illustrated) provided in the lower part of the fuselage 11, and contributes to cooling the non-pressurized compartment C3 (refer to F3).

The conditioned air generated by the air conditioner 180 circulates as illustrated by F1, F2-1, F2-2, and F3, and is finally discharged outward of the aircraft from the non-pressurized compartment C3 through a louver (not illustrated) provided in the belly fairing 17 (refer to F4).

[Heat Input caused by Internal Heat Source and External Solar Radiation]

While the aircraft 2 is parked outdoors, the sunlight is incident on the airframe with the incident intensity corresponding to regions, weather, seasons, and time zones.

Therefore, for example, the belly fairing 17 is heated from the inside by the heat generated from the heat source such as the bleed air pipe and the accessory which are installed in the non-pressurized compartment C3, and is heated from the outside by the incident sunlight illustrated by Sb in FIG. 15.

For example, Sb corresponds to the sunbeam directly incident on the side walls 17A and 17C of the belly fairing 17 in morning and evening time zones. In this case, particularly when dark color coating or film having a high absorption rate of sunlight is applied to the outside of the side walls 17A and 17C, the amount of the heat input to the side walls 17A and 17C increases due to the solar radiation.

The lower wall 17B on which the sunbeam is not directly incident is less affected by the heat generated due to the solar radiation, compared to the side walls 17A and 17C. However, the lower wall 17B is close to the ground. Accordingly, in some cases, the lower wall 17B may also be heated by heat radiation from the ground having a high temperature due to the solar radiation or discharged gas from the airframe.

The non-pressurized compartment C3 is ventilated by the above-described conditioned air distribution system s1. However, even under conditions that the heat is radiated to the belly fairing 17 from the heat source such as the bleed air pipe and the sunlight is incident on the belly fairing 17, the structural member 171 of the belly fairing 17 needs to maintain the allowable or lower temperature. The allowable temperature is determined from a viewpoint of maintaining the structural member 171 in a sound state in view of required strength or rigidity. In particular, when the structural member 171 is formed of a composite material (fiber reinforced resin), the allowable temperature is lower, compared to a case where the structural member 171 is formed of an aluminum alloy.

A volume of the non-pressurized compartment C3 inside the belly fairing 17 is limited due to aerodynamic performance of the aircraft 2 or a demand for weight reduction. In particular, in small aircraft or medium-sized aircraft, the non-pressurized compartment C3 tends to be narrowed compared to an accommodation volume of various members. In this case, even when the non-pressurized compartment C3 is ventilated, heat density in the non-pressurized compartment C3 tends to be higher than that in the non-pressurized compartment C3 of the large aircraft, due to the radiation from the internal heat source and the incident sunlight from the outside.

Furthermore, due to mounting restrictions in accommodating a lot of pipes, electric wires, and various accessories in the non-pressurized compartment C3, in some cases, the heat source may have to be disposed close to the structural member 171 of the belly fairing 17. The mounting restrictions tend to increase in the small aircraft or the medium-sized aircraft having the narrow non-pressurized compartment C3.

[Heat Input Reducing System]

The aircraft 2 of the present embodiment includes the heat input reducing system 3 including a heat input reducing system s2 that maintains a target region 171A from which the heat is radiated from the heat source in the structural member 171, at an allowable or lower temperature, under conditions that the heat is radiated from the heat source such as the bleed air pipe to the belly fairing 17 in which a composite material is used for the structural member 171 and the sunlight is incident on the belly fairing 17. The heat input reducing system s2 includes a heat input reducing structure 130 including the structural member 171 and a heat blocking material 131. The heat input reducing system s2 maintains the target region 171A at the allowable or lower temperature by causing at least the heat blocking material 131 to reduce the heat input to the target region 171A of the structural member 171.

The structural member 171 includes the target region 171A and the above-described mixed region 112 (FIG. 16A). When a part of an inner surface of the structural member 171 is the target region 171A, it is preferable that the mixed region 112 extends over a range corresponding to at least the target region 171A on the outer surface of the structural member 171.

The heat input reducing system 3 includes the heat input reducing system s2, the fuselage 11, the air conditioner 180 disposed in the non-pressurized compartment C3 inside the belly fairing 17, the heat sources (21 and 24) close to the target region 171A of and the structural member 171 forming the belly fairing 17, and the above-described conditioned air distribution system s1.

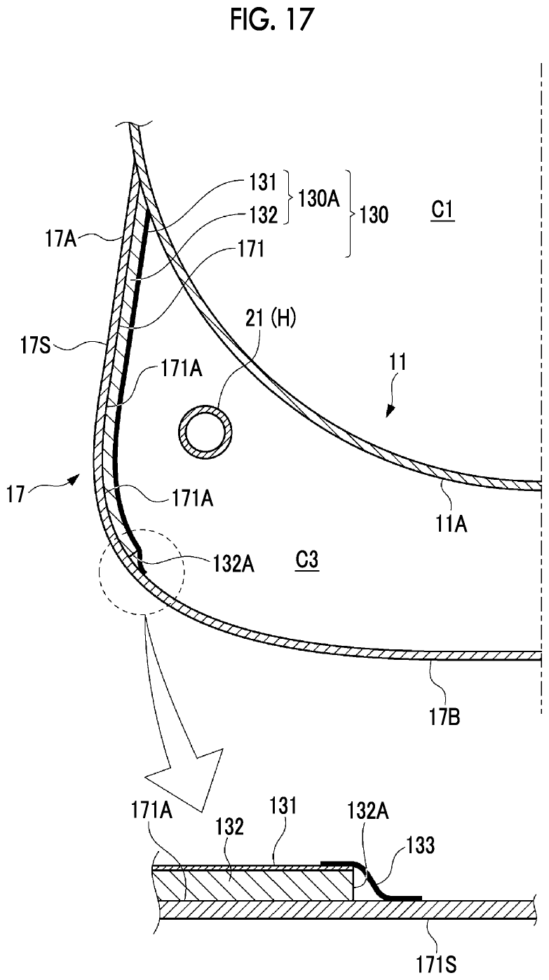

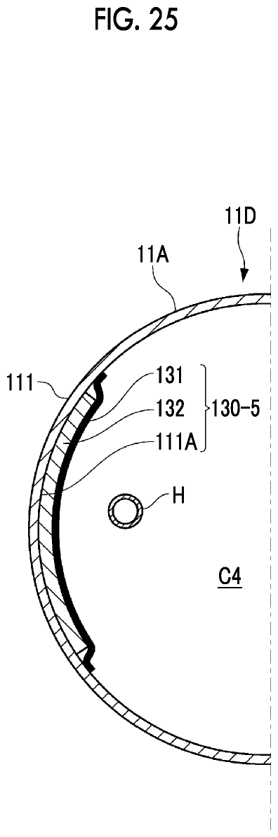

Hereinafter, in first to fourth embodiments (FIGS. 17 to 23), structures 130, 130-1, 130-2, 130-3, and 130-4 which reduce the heat input to the structural member 171 of the belly fairing 17 forming the non-pressurized compartment C3 will be described. Thereafter, in the fifth embodiment (FIGS. 24 and 25), a heat input reducing structure 130-5 in a non-pressurized compartment C4 of a rear part 11D of the fuselage 11 will be described.

All of the heat input reducing structures 130, 130-1, 130-2, 130-3, 130-4, and 130-5 include the structural member 171 of the belly fairing 17, the structural member 111 of the rear part 11D of the fuselage 11, structural members forming the non-pressurized compartments C2, C3, and C4 in which the heat is likely to internally stay, and a heat blocking material (131 or the like) which contributes to heat input reducing. For example, the mixed region 112 illustrated in FIG. 16A is provided on the outer surface of the structural member. The heat input is reduced by the mixed region 112 with regard to the solar radiation on the structural member from the outside, and the heat input is reduced by at least the heat blocking material with regard to the heat radiation from the internal heat source. According to this configuration, even in a thermally severe situation caused by the solar radiation and internally staying heat, an increase in the temperature of the structural member can be reduced, and the structural member can maintain the allowable or lower temperature.

### First Embodiment

The heat input reducing structure 130 of the first embodiment illustrated in FIG. 17 includes the structural member 171 forming the non-pressurized compartment C3, a heat blocking material 131 disposed between and the target region 171A and a heat source H in the structural member 171, and a heat insulating material 132 that covers the target region 171A from the inside of the non-pressurized compartment C3. The heat blocking material 131 is disposed between the heat insulating material 132 and the heat source H (bleed air pipe 21).

Although FIG. 17 illustrates only the port side where the bleed air pipe 21 is disposed, it is preferable that a starboard side where the bleed air pipe 24 (FIG. 15) is disposed also includes the heat input reducing structure 130 including the heat blocking material 131 as in the port side.

(Structural Member)

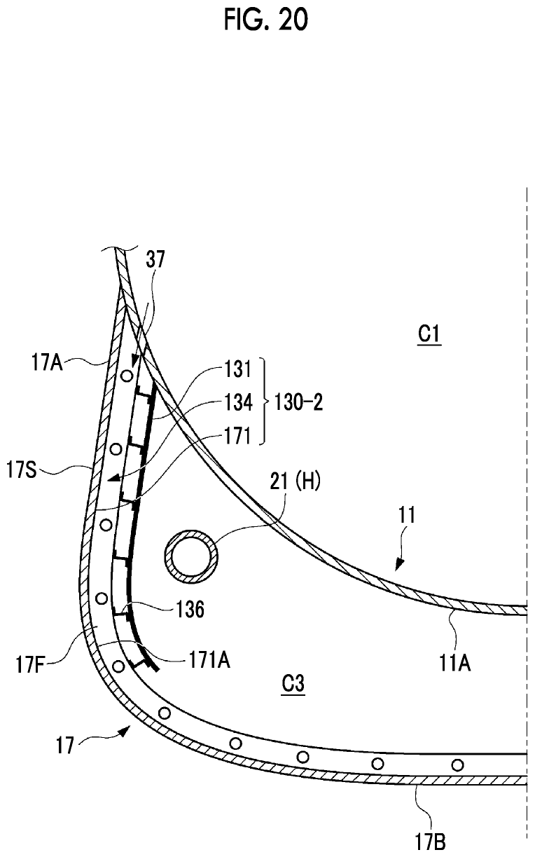

The structural member 171 corresponds to the skin forming the belly fairing 17 and a frame supporting the skin. FIG. 17 schematically illustrates a skin 17S as the structural member 171. The frame is not indicated in a cross section of the belly fairing 17 illustrated in FIG. 17. For example, as in a frame 17F illustrated in FIG. 20, the frame is formed in a substantially U-shape over the side wall 17A, the lower wall 17B, and the side wall 17C of the belly fairing 17. A plurality of the frames 17F are disposed at an interval in a direction orthogonal to the paper surface of FIG. 20.

The structural member 171 of the present embodiment is entirely or partially formed of a fiber reinforced resin containing a reinforcing fiber. Since the fiber reinforced resin having higher specific strength than a metallic material is adopted, while strength and rigidity required for the structural member 171 can be ensured, the weight of the structural member 171 can be reduced, and the reduced weight can contribute to improved fuel efficiency. For example, glass fiber reinforced plastics (GFRP) containing a glass fiber as a reinforcing fiber can be adopted for the skin 17S of the target region 171A of the structural member 171.

The present embodiment is configured so that the skin 17S of the target region 171A is formed of a fiber reinforced resin, and the frame of the target region 171A is formed of an aluminum alloy. However, without being limited thereto, the frame may be formed of the fiber reinforced resin having the same type as the skin 17S or the fiber reinforced resin having a different reinforcing fiber.

(Heat Source)

The heat source H disposed in the non-pressurized compartment C3 corresponds here to the bleed air pipe 21 through which high-temperature and high-pressure bleed air flows. For example, the bleed air having a high temperature of 200° C. flows through the bleed air pipe 21. As a typical example, the bleed air pipe 21 is provided with a heat insulating cover (not illustrated) including the heat insulating material. Accordingly, the heat radiation from the bleed air pipe 21 to the surroundings is reduced. However, in order to reliably prevent an ambient temperature around the bleed air pipe 21 from exceeding the allowable temperature in the target region 171A close to the bleed air pipe 21, the heat input reducing structure 130 is required.

Even when the target region 171A is formed of an aluminum alloy, the heat input reducing structure 130 is required depending on the ambient temperature around the bleed air pipe 21.

The heat source H is not limited to the bleed air pipe 21, and for example, may be a housing of the air conditioner 180 into which the bleed air flows.

(Target Region)

The structural member 171 faces the heat source H in a close state. The target region 171A means the following region. When the structural member 171 of the parked airframe is irradiated with a sunbeam Sb (FIG. 15) and a heat ray is radiated from the heat source H to the structural member 171, as long as there exist no element that reduces the heat input such as the heat blocking material 131 and the heat insulating material 132, the heat ray radiated from the heat source H is incident on the target region 171A with the incident intensity sufficient to increase the temperature of the target region 171A.

For example, even when the heat source H and the target region 171A are close to each other at a distance of approximately ten to several tens of mm, the heat blocking material 131 disposed between the target region 171A and the heat source H blocks the heat radiated to the target region 171A from the heat source H for the target region 171A. In this manner, the heat input to the target region 171A can be reduced, and the target region 171A can maintain the allowable or lower temperature.

The target region 171A can be set to an appropriate range in the structural member 171, depending on the distance from the heat source H or the temperature of the heat source H.

The bleed air pipe 21 extends in a direction intersecting with the paper surface of FIG. 17. It is preferable that the target region 171A also extends along a length direction of the bleed air pipe 21. The target region 171A includes the skin 17S serving as the structural member 171 and the frame 17F (FIG. 20).

When there exist a plurality of the heat sources H, a range of the target region 171A in which the heat blocking material 131 is installed may be set, depending on each temperature of the plurality of heat sources H or the distance between each heat source H and the structural member 171.

In an example illustrated in FIG. 17, the target region 171A is set on the side wall 17A, but the configuration is not limited thereto. The target region 171A may be set on the lower wall 17B, depending on the position of the heat source H or the distance between the heat source H and the structural member 171. In this case, the heat input reducing structure 130 includes the heat blocking material 131 disposed between the target region 171A set on the lower wall 17B and the heat source H.

(Heat Blocking Material)

The heat blocking material 131 is disposed over the whole target region 171A between the target region 171A and the heat source H. Emissivity of the heat blocking material 131 is lower than emissivity of the fiber reinforced resin used for the target region 171A. The heat blocking material 131 blocks radiant heat for the target region 171A by reflecting the heat radiated from the heat source H, based on the emissivity. The heat input to the target region 171A can be reduced by using a blocking effect of the heat blocking material 131 which blocks the radiant heat.

From viewpoints of specific gravity, costs, corrosion resistance, and availability, it is preferable that the surface on at least the heat source H side in the heat blocking material 131 is formed of aluminum, or an aluminum alloy to which one or more elements from Mn, Si, Mg, Cu, and Zn are added by using the aluminum as a main component.

For example, a representative value of the emissivity of the aluminum is 0.04 to 0.06, and the value is sufficiently lower than the emissivity of 0.8 to 0.95 of the fiber reinforced resin. The emissivity varies depending on a surface state, a measured temperature, or a measured wavelength.

The aluminum and the aluminum alloy have lower specific gravity than copper, and thus, are suitable for applications to the aircraft.

The heat blocking material 131 is provided with heat resistance against the heat radiated from the bleed air pipe 21 through a heat insulating cover (not illustrated). As the heat blocking material 131, for example, the aluminum alloy having a heat resistant temperature of 100° C. to 120° C. can be used.

As the heat blocking material 131, for example, an aluminum rolled material formed of the aluminum alloy, or an aluminum vapor deposition film in which a vapor deposition film is formed on a preform by using a physical vapor deposition method or a chemical vapor deposition method of using the aluminum alloy can be adopted.

In order to lower the emissivity and further improve the effect of the heat blocking material 131 which blocks the radiant heat, it is preferable to add gloss to the surface of the heat blocking material 131 by means of polishing or to adopt the vapor deposition film for the heat blocking material 131.

(Heat Insulating Material)

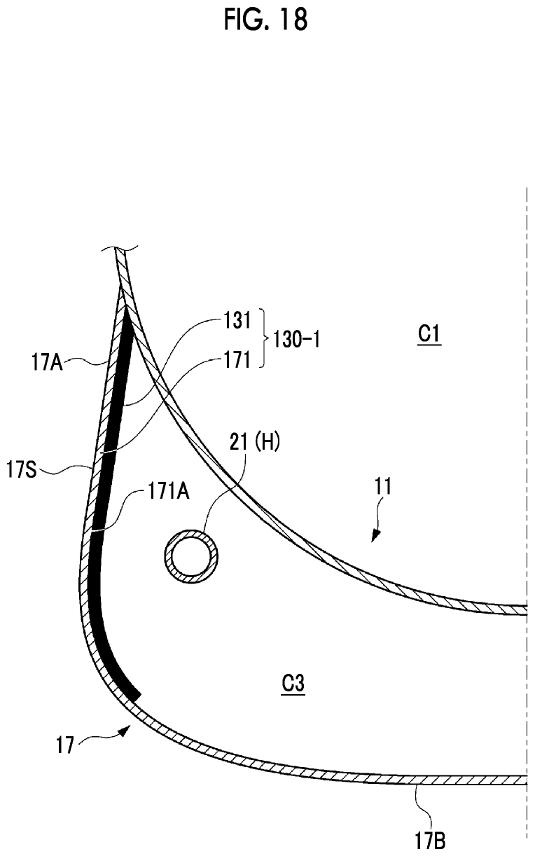

For example, the heat insulating material 132 is configured in a form in which a lot of gaps are included by using a material having low thermal conductivity such as a resin material. The heat insulating material 132 reduces possibilities that the heat transferred from the heat source H to the heat insulating material 132 via the heat blocking material 131 may be conducted to the target region 171A. Since the heat insulating material 132 is disposed between the heat blocking material 131 and the target region 171A, the heat input to the target region 171A can be more sufficiently reduced, compared to a case where the heat blocking material 131 is used alone (FIG. 18).

As the heat insulating material 132, for example, it is preferable to use a sheet formed of a resin foam formed by foaming melamine or a resin material such as polyimide.

The melamine or the resin foam such as the polyimide contains a lot of fine bubbles on the order of pm. Therefore, thermal conductivity of the resin and the bubbles as a whole is sufficiently low.

The resin material used for the heat insulating material 132 has sufficient heat resistance against the heat transferred from the bleed air pipe 21 via a heat insulating cover (not illustrated) and the heat blocking material 131. A heat resistant temperature of the melamine is approximately 180° C., and a heat resistant temperature of the polyimide is 500° C. or higher.

As the heat insulating material 132, either a closed cell resin foam or an open cell resin foam can be adopted. From a viewpoint of obtaining flame retardancy (low flame propagation) and hydrophobicity, it is preferable to adopt the closed cell resin foam.

(Heat Blocking Material and Heat Insulating Material)

According to the heat input reducing structure 130, in addition to blocking the radiant heat by the heat blocking material 131, and the thermal conduction is reduced by the heat insulating material 132. In this manner, compared to a case where the heat blocking material 131 is used alone or a case where the heat insulating material 132 is used alone, the heat input to the target region 171A can be more sufficiently reduced. Therefore, even when the fiber reinforced resin having a lower allowable temperature than the aluminum is used for the target region 171A, the thicknesses of the heat blocking material 131 and the heat insulating material 132 as a whole are reduced. While an increase in the weight of the airframe can be avoided, the target region 171A can reliably maintain the allowable or lower temperature.

In this case, as the fiber reinforced resin used for the structural member 171, it is not necessary to select a high-grade product having a higher allowable temperature. Accordingly, manufacturing costs of the belly fairing 17 can be reduced.

Furthermore, when structural member 171 maintains the allowable or lower temperature by reducing the heat input caused by the internal heat source H, the dark color having a high light absorption rate of sunlight can be adopted as the exterior color. Therefore, the exterior color of the airframe including the target region 171A is more freely and widely selected.

In the present embodiment, a laminate 130A in which the heat blocking material 131 and the heat insulating material 132 are integrated is adopted. For example, the laminate 130A includes the heat insulating material 132 formed of the above-described melamine foam and the heat blocking material 131 laminated on the surface of the heat insulating material 132 and formed of a glossy aluminum alloy film.

When the heat blocking material 131 and the heat insulating material 132 are laminated and integrated, both can be constructed in the target region 171A at once.

(Seal of Heat Insulating Material)

In the non-pressurized compartment C3, a liquid such as rainwater, dew condensation water, or hydraulic oil used in a hydraulic system may exist. Therefore, it is preferable that the heat insulating material 132 is sealed between at least the heat blocking material 131 out of the heat blocking material 131 and other members (tape 133 and the like) and the structural member 171 around the target region 171A. The reason is to avoid the following possibility. The heat insulating material 132 comes into contact with the hydraulic oil, and the liquid entering the heat insulating material 132 is cooled and frozen in the sky due to takeoff and landing. Thereafter, the liquid is repeatedly melted, thereby causing a change in quality or deterioration of the heat insulating material 132. Since the heat insulating material 132 is sealed, a life of the heat insulating material 132 can be extended.

Therefore, it is preferable that the surface of the heat insulating material 132 is covered over the entire region with the heat blocking material 131. In this case, the heat blocking material 131 is provided with an area equal to or larger than an area of the heat insulating material 132.

In addition, it is preferable that an end edge 132A of the heat insulating material 132 is covered over the entire periphery in a plan view with the heat blocking material 131 having a larger area than the heat insulating material 132, or is covered with other members.

As an example of the latter, as illustrated in an enlarged view of a location surrounded by a broken line circle in FIG. 17, the end edge 132A of the heat insulating material 132 exposed from the heat blocking material 131 is covered over the entire periphery with the tape 133 serving as the other member. The tape 133 is joined to the outer peripheral part of the heat blocking material 131 that covers the surface of the heat insulating material 132 and the structural member 171 around the end edge 132A by an adhesive layer. In this case, the heat insulating material 132 is sealed among the heat blocking material 131, the tape 133, and the structural member 171.

When the surface of the tape 133 is provided with a layer formed of aluminum or an aluminum alloy, the radiant heat from the heat source H is reflected by the tape 133. Accordingly, the tape 133 can contribute to reducing the heat input to the target region 171A. For example, the tape 133 includes a heat blocking layer formed of the aluminum alloy by means of rolling and an adhesive layer on a back side of the heat blocking layer.

The tape 133 does not necessarily have to be formed of a material having low emissivity such as the aluminum. The tape 133 may be formed of an appropriate material as long as the tape 133 has required properties such as heat resistance against the radiant heat from the heat source H and weather resistance.

(Construction of Heat Insulating Material and Heat Blocking Material)

For example, the laminate 130A can be installed in the skin 17S of the target region 171A by using an adhesive agent. Alternatively, when an adhesive layer (not illustrated) is provided on a back surface of the heat insulating material 132 of the laminate 130A, a release paper covering the adhesive layer can be detached, and the laminate 130A can be installed in the skin 17S by using the adhesive layer. The heat insulating material 132 and the heat blocking material 131 have a light weight in terms of each thicknesses and each specific gravity. Accordingly, the laminate 130A can be stably installed in the structural member 171 only by means of bonding or adhesion without requiring other joining means such as fastening.

The laminate 130A can be cut into an appropriate dimension and shape when necessary, and the laminate 130A can be disposed without a gap on the skin 17S between the frames corresponding to the target region 171A.

The heat insulating material 132 and the heat blocking material 131 do not necessarily have to be integrated. Therefore, the heat insulating material 132 and the heat blocking material 131 which are separately configured may be constructed by being sequentially overlapped with each other on the target region 171A. Even in this case, it is preferable to use the adhesive or the adhesive layer respectively provided in the heat insulating material 132 and the heat blocking material 131.

### Other Modification Examples of First Embodiment

In an example illustrated in FIG. 18, the heat blocking material 131 is independently installed in the target region 171A. Depending on the temperature of the heat source H, the distance between the heat source H and the target region 171A, the allowable temperature corresponding to a material of the target region 171A, the exterior color of the structural member 171 including the target region 171A, as in the example illustrated in FIG. 18, the heat insulating material 132 may not be interposed between the heat blocking material 131 and the target region 171A.

For example, when the temperature of the heat source H and the distance between the heat source H and the target region 171A are similar to those in the example illustrated in FIG. 17, and when the target region 171A is formed of the aluminum alloy, or when the exterior color of the structural member 171 including the target region 171A is the white color, a heat input reducing structure 130-1 illustrated in FIG. 18 can be adopted.

### Second Embodiment

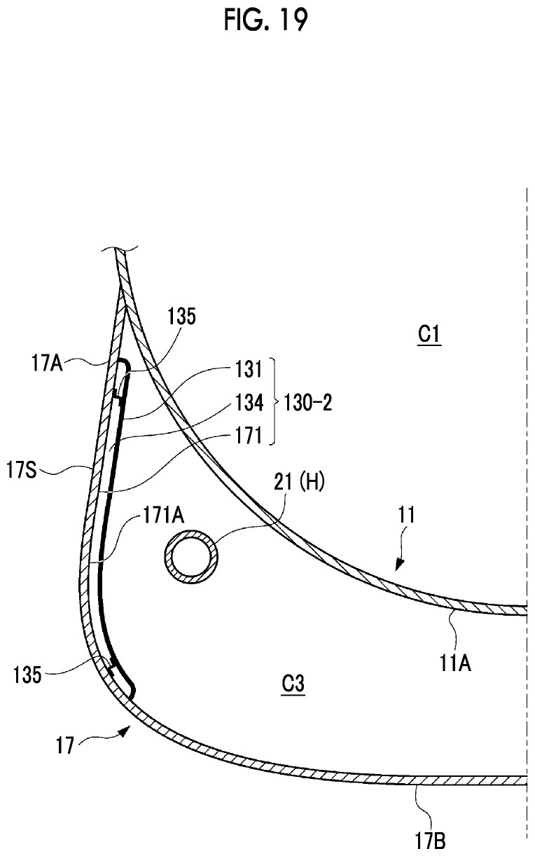

Next, a heat input reducing structure 130-2 according to a second embodiment and modification examples thereof will be described with reference to FIGS. 19 to 21. Hereinafter, items different from those of the first embodiment will be mainly described. The same reference numerals will be assigned to the same components as those in the first embodiment.

The heat input reducing structure 130-2 includes the heat blocking material 131 and an air layer 134 corresponding to a gap between the heat blocking material 131 and the target region 171A.

According to the heat input reducing structure 130-2, the heat radiated from the heat source H is blocked by the heat blocking material 131, and the thermal conduction from the heat blocking material 131 to the target region 171A is reduced by the air layer 134. In this manner, the heat input to the target region 171A can be sufficiently reduced, and the target region 171A can maintain the allowable or lower temperature.

In an example illustrated in FIG. 19, an upper end portion and a lower end portion of the heat blocking material 131 are bent toward the target region 171A. Accordingly, convection in the air layer 134 is reduced. For example, the heat blocking material 131 is installed in the skin 17S by using a bracket 135. Thermal resistance is added between the heat source H and the target region 171A by the air layer 134 in which the convection is reduced. In this manner, the heat input to the target region 171A can be more sufficiently reduced.

The upper end portion and the lower end portion of the heat blocking material 131 may not be bent. In this case, for example, an end portion of the heat blocking material 131 supported by the bracket 135 and the skin 17S are fixed by the tape 133 (FIG. 17). In this manner, the air layer 134 can be added between the heat blocking material 131 and the target region 171A.

### First Modification Example of Second Embodiment

The heat blocking material 131 may be supported by the frame 17F as in an example illustrated in FIG. 20. The bracket 136 can be used when necessary. Even in this case, the air layer 134 is added between the heat blocking material 131 and the skin 17S of the target region 171A.

When the thickness of the air layer 134 is set to a minute dimension or the air layer 134 is surrounded by an appropriate member, the heat input to the target region 171A can be reduced by thermal resistance of the air layer 134 in which the convection is reduced.

Contrary to the above-described configuration, the air is caused to flow into and out from the air layer 134 to promote the convection. In this manner, the promoted convection can also contribute to reducing the heat input to the target region 171A by preventing the heat from staying in the air layer 134. In this case, for example, as illustrated in FIG. 20, the heat input reducing structure 130-2 includes an air supply path 137 that supplies the air to the vicinity of the target region 171A from the pressurized compartment C1 inside the fuselage 11.

For example, the air supply path 137 may be a duct branched from a duct that discharges the conditioned air passing through the cabin 1B or the electronic device storage spaces 1D and 1E to the non-pressurized compartment C3, or may be a gap between members forming the lower part of the fuselage 11. A position and an orientation of the air supply path 137 may be appropriately set so that the air flows into the air layer 134 through the air supply path 137.

The air flows into and out from the air layer 134 through the air supply path 137. Accordingly, it is possible to avoid the heat from staying in the vicinity of the target region 171A. Moreover, the target region 171A is cooled by supplying the air having a temperature lower than the ambient temperature of the non-pressurized compartment C3 to the target region 171A through the air supply path 137. Therefore, the amount of the heat input to the target region 171A can be sufficiently reduced.

### Second Modification Example of Second Embodiment

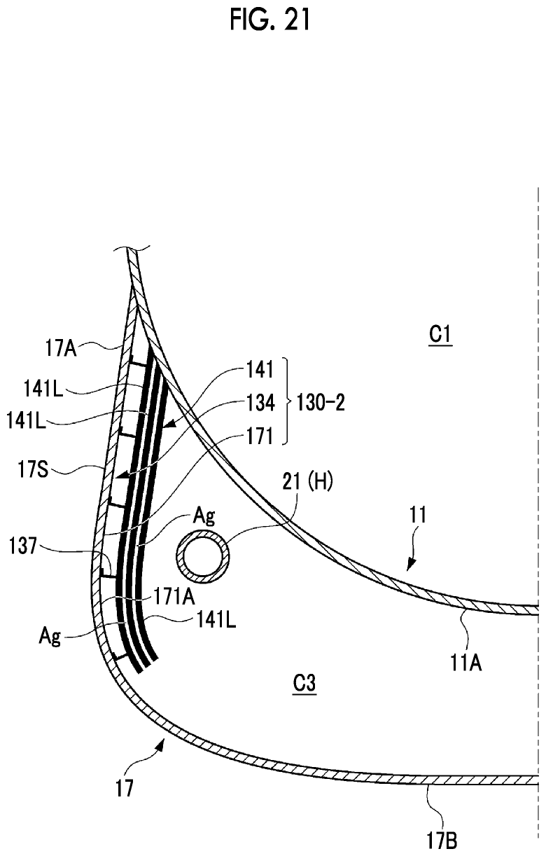

FIG. 21 illustrates a heat blocking material 141 serving as a laminate in which a heat blocking effect is improved by providing a plurality of layers 141L. For example, the layer 141L may be a rolled material formed of the aluminum alloy, or may be configured so that a vapor deposition film formed of the aluminum alloy is provided in a film preform. Alternatively, the layer 141L may be configured so that an aluminum alloy film is laminated on a resin foam such as the above-described melamine foam. In this case, the layer 141L is disposed so that the aluminum alloy film is directed toward the heat source H.

Even when each layer 141L has any one of the above-described configurations, the emissivity of each of the plurality of layers 141L is sufficiently lower than that of the target region 171A, based on the emissivity of the aluminum.

Therefore, the heat energy can be attenuated in such a manner that the heat ray radiated from the heat source H is reflected by each of the plurality of layers 141L, and the heat input to the target region 171A can be more sufficiently reduced.

When an air layer Ag is added between the layers 141L in addition to the plurality of layers 141L which are laminated, a heat insulation effect of the air layer Ag can also be obtained. Therefore, it is possible to improve an effect of reducing the heat input to the target region 171A.

As in the heat blocking material 131 in FIG. 14, the heat blocking material 141 can be directly installed in the skin 17S by using the adhesive agent. However, in an example illustrated in FIG. 21, as in FIGS. 19 and 20, the air layer 134 is added between the heat blocking material 141 and the target region 171A. When the convection is promoted in the air layer 134 to reduce the heat input to the target region 171A, the air supply path 137 illustrated in FIG. 20 may be adopted for a structure illustrated in FIG. 21.

### Third Embodiment

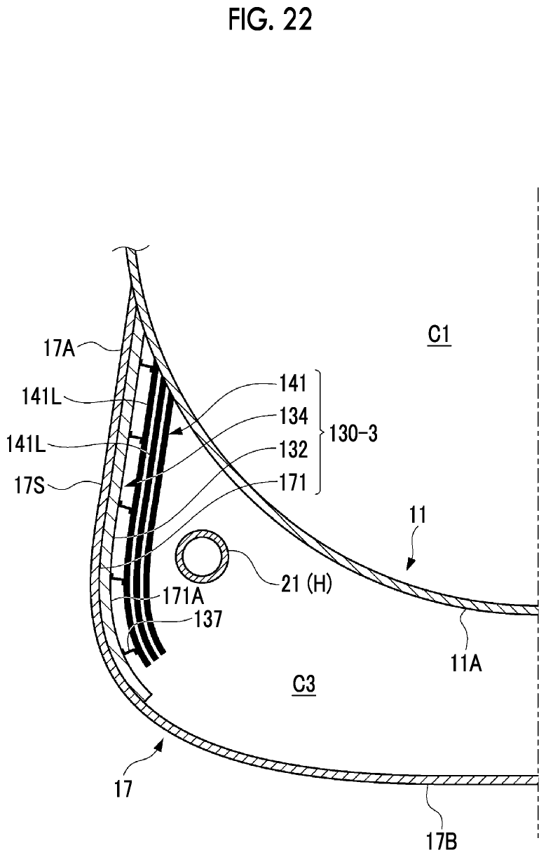

A heat input reducing structure 130-3 illustrated in FIG. 22 is configured to add the heat insulating material 132 to the heat input reducing structure 130-2 in FIG. 21, and the air layer 134 is formed between the heat blocking material 141 and the heat insulating material 132. Here, the heat blocking material 141 including the plurality of layers 141L is adopted. However, the heat blocking material 131 (FIG. 17) including a single layer formed of the aluminum alloy may be adopted.

According to the heat input reducing structure 130-3, the heat insulation effect is obtained by the heat insulating material 132. In this manner, the amount of the heat input to the target region 171A can be further reduced, compared to the modification example (FIG. 21) of the second embodiment.

When necessary, the air supply path 137(FIG. 20) for allowing the air to flow into the air layer 134 from the pressurized compartment C1 can also be adopted.

### Fourth Embodiment

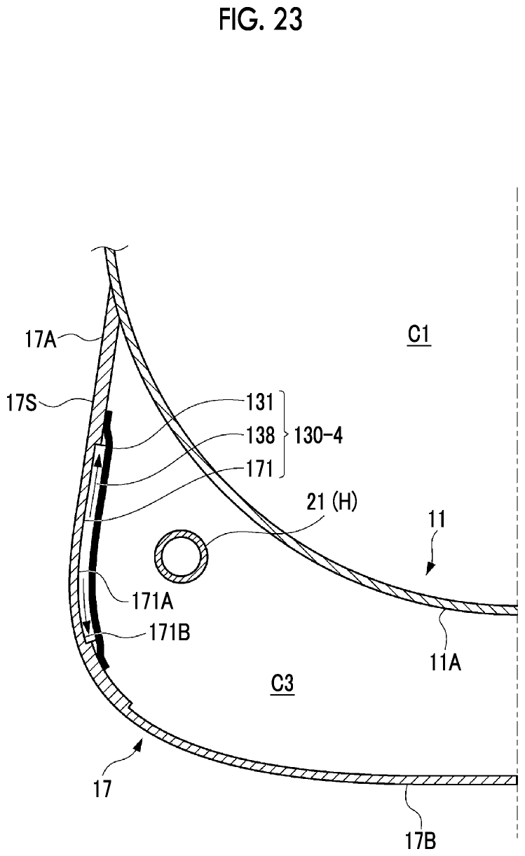

In addition to the heat blocking material 131, a heat input reducing structure 130-4 illustrated in FIG. 23 includes a heat diffusing material 138 diffusing the heat by being disposed between the heat blocking material 131 and the target region 171A. The heat diffusing material 138 is provided with anisotropy for diffusing the heat in a plane direction of the target region 171A.

As the heat diffusing material 138, for example, a film formed of graphite can be used. The anisotropy of the graphite film is based on a crystal structure of the graphite.

The heat diffusing material 138 formed of the graphite film has significantly higher thermal conductivity than that of copper or aluminum having high thermal conductivity in general materials, in terms of thermal conduction in an in-plane direction. For example, the thermal conductivity of the heat diffusing material 138 in a thickness direction remains at approximately 1/300 to 1/100 of the thermal conductivity in the plane direction. For example, a heat resistant temperature of the graphite film is 400° C.

The graphite film is manufactured through a preliminary sintering treatment for obtaining a precursor by decomposing a polymer material such as polyimide under high temperature heating, and a main sintering treatment for growing a graphite crystal from the precursor by further heating.

The heat diffusing material 138 can be formed of a single graphite film or a plurality of laminated graphite films. For example, a total thickness of the heat diffusing material 138 is approximately 0.1 to 1 mm. The specific gravity of the graphite is lower than the specific gravity of the aluminum or the copper. Therefore, it is possible to reduce an increase in the weight of the airframe which is caused by the added heat diffusing material 138.

In an example illustrated in FIG. 23, the heat diffusing material 138 having a dimensional shape corresponding to a recessed portion 171B formed in the skin 17S is positioned inside the recessed portion 171B, and the heat diffusing material 138 is installed over the target region 171A corresponding to a bottom portion of the recessed portion 171B by using an adhesive layer (not illustrated). Without being limited thereto, the heat diffusing material 138 may be installed on the skin 17S in which the recessed portion 171B is not formed.

When the heat blocking material 131 and the heat diffusing material 138 are integrated in a state where the heat blocking material 131 is laminated on the heat diffusing material 138, it is preferable since both of these can be constructed in the target region 171A at once.

In order to maintain characteristics of the heat diffusing material 138, it is preferable to avoid water or hydraulic oil from adhering to the heat diffusing material 138. Therefore, as in the heat insulating material 132 in FIG. 17, it is preferable that the heat diffusing material 138 is sealed between at least the heat blocking material 131 out of other members such as the heat blocking material 131 and the tape 133 (FIG. 17) and the structural member 171.

When the heat diffusing material 138 exists in a heat propagation path from the heat source H to the target region 171A, the heat diffusing material 138 rapidly diffuses the heat in the plane direction as illustrated by an arrow. In this case, a peak temperature in a temperature distribution of the target region 171A decreases, compared to a case where the heat diffusing material 138 is not used, and a temperature gradient becomes gentle. As a result, the entire target region 171A can maintain the allowable or lower temperature while avoiding the target region 171A from being locally heated.

The heat diffusing material 138 can be installed in at least a part of the target region 171A, based on the ambient temperature around the heat source H, the temperature distribution of the target region 171A, or the allowable temperature of the target region 171A. As a matter of course, the heat diffusing material 138 may be installed over a wider range than the target region 171A in the structural member 171.

According to the heat input reducing structure 130-4 of the fourth embodiment, while the heat radiated from the heat source H is blocked for the target region 171A by the heat blocking material 131, thermal conduction in the plane direction is promoted by the heat diffusing material 138. In this manner, the heat input to the target region 171A can be sufficiently reduced, and the target region 171A can maintain the allowable or lower temperature.

The heat blocking material 141 (FIG. 21) can also be used instead of the heat blocking material 131.

The heat blocking materials 131 and 141, the heat insulating material 132, the air layer 134, and the heat diffusing material 138 which are described above are not limited to examples in the above-described first to fourth embodiments, and can be appropriately combined with each other.

For example, in the fourth embodiment, the air layer 134 can be set between the heat diffusing material 138 and the target region 171A, or the heat insulating material 132 can be disposed between the heat diffusing material 138 and the target region 171A.

### Fifth Embodiment

Next, a heat input reducing structure 130-5 according to a fifth embodiment will be described with reference to FIGS. 24 and 25. The heat input reducing structure 130-5 is provided in the rear part 11D located on the tail 13 and 14 sides of the fuselage 11.

FIG. 24 illustrates the non-pressurized compartment C4 partitioned between the pressure bulkhead W1 and the rear bulkhead W2 inside the fuselage 11. The auxiliary power unit 16 is installed behind the rear bulkhead W2. The bleed air pipe (heat source H) through which the bleed air obtained from the auxiliary power unit 16 flows extends forward of the air conditioner 180 (FIG. 15). In the non-pressurized compartment C4, in addition to the bleed air pipe (heat source H), for example, accessories 28 and 29 such as a hydraulic pump are installed.

Unlike during flight, while the aircraft is parked, the non-pressurized compartment C4 is less likely to be sufficiently ventilated through openings 101, 102, and 103. Therefore, the ambient temperature of the non-pressurized compartment C4 is likely to increase due to staying heat. In this case, the structural member 111 such as the skin and the frame which form the rear part 11D of the fuselage 11 is heated from the inside by the heat generated from the heat sources such as the bleed air pipe (heat source H) and the accessory 28 and 29, and is also heated from the outside by the incident sunlight.

Even under this condition, since the heat input reducing structure 130-5 (FIG. 25) is provided in the rear part 11D, the structural member 111 of the rear part 11D can maintain the allowable or lower temperature. In addition, the dark color such as the black color having a high light absorption rate of sunlight can be adopted for the exterior color of the rear part 11D.

The heat input reducing structure 130-5 illustrated in FIG. 25 is configured in the same manner as the heat input reducing structure 130 of the first embodiment, except that a target region 111A set in the structural member 111 of the rear part 11D is provided. For example, the target region 111A is formed of a fiber reinforced resin such as GFRP.

Instead of the heat input reducing structure 130, any of the above-described heat input reducing structures 130-1, 130-2, 130-3, and 130-4 can be adopted.

In addition to the above-described configurations, the configurations in the above-described embodiments can be optionally selected, or can be appropriately changed to another configuration without departing from the concept of the present disclosure.

[Additional Notes]

The heat input reducing structure for the aircraft, the heat input reducing system, the aircraft, and the aircraft manufacturing method which are described above can be understood as follows.

(1) The heat input reducing structure for the aircraft 1 includes the mixed region 112 in which the first color R1 similar to the color applied to the adjacent region and the second color R2 having the lower absorption rate of sunlight than the first color R1 are mixed in a predetermined color distribution pattern on the outer surface of a part of the airframe. In the mixed region 112, the reflective material that contributes to an increase in the reflection rate of sunlight is added to the part in which at least the first color R1 is provided in the mixed region 112.

(2) In the mixed region 112, the area ratio occupied by the second color R2 gradually increases upward from below.

(3) The mixed region 112 is located above the adjacent region to which the same color as the first color R1 is applied.

(4) The part of the first color R1 and the part of the second color R2 in the mixed region 112 form the color distribution pattern in which the basic shapes are regularly or irregularly disposed.

(5) The mixed region 112 is provided in the exterior film that covers the outer surface of the airframe 10.

(6) The mixed region 112 is located in the vicinity of the vertical tail 13 erected from the fuselage 11 forming the airframe 10, in the fuselage 11.

(7) The mixed region 112 is located on the side surface of the fairings 17 and 19 provided on the lower side of the fuselage 11 forming the airframe 10, or on the side surface of the vertical tail 13 forming the airframe 10.

(8) The member forming a part of the airframe 10 where the mixed region 112 is located is formed of a fiber reinforced resin.

(9) The non-pressurized compartment C2 which is not pressurized exists inside a part of the airframe 10 in which the mixed region 112 is located.

(10) The compartment C2 in which the heat source is disposed exists inside a part of the airframe 10 in which the mixed region 112 is located.

(11) The compartment C2 in which at least the temperature control out of the forced ventilation and the temperature control is not performed by the air conditioning system provided in the aircraft exists inside a part of the airframe 10 in which the mixed region 112 is located.

(12) The aircraft 1 includes the airframe 10 and the above-described heat input reducing structure applied to a part of the airframe 10.

(13) The method of manufacturing the aircraft 1 after coating the airframe 10 includes Step S101 of forming the first coating film (31) by applying the coating material of the first color R1 similar to the color applied to the adjacent region to the mixed region 112 located on the outer surface of a part of the airframe 10 in a predetermined color distribution pattern, and Step S103 of forming the second coating film (33) formed by transferring the coating material of the second color R2 having the lower absorption rate of sunlight than the first color R1 so that the first color R1 and the second color R2 are mixed.

(14) The method of manufacturing the aircraft 1 after coating the airframe 10 includes Step S111 of forming the first coating film by applying the coating material of the first color R1 similar to the color applied to the adjacent region to the mixed region 112 located on the outer surface of a part of the airframe 10 in a predetermined color distribution pattern, and Step S113 of forming the second coating film by using the coating material of the second color R2 having the lower absorption rate of sunlight than the first color R1 after masking the location to which the first color R1 is applied so that the first color R1 and the second color R2 are mixed.

(15) The method of manufacturing the aircraft further includes Steps S102 and S114 of applying the coating material containing the reflective material that contributes to an increase in the reflection rate of sunlight to the location to which at least the first color R1 out of the first color R1 and the second color R2 is applied.

(16) The method of manufacturing the aircraft after application of the exterior film to the airframe includes Step S22 of covering at least a part of the airframe 10 with the exterior film including the mixed region 112. In the mixed region 112, the first color R1 similar to the color applied to the region adjacent to the mixed region 112 and the second color R2 having the lower absorption rate of sunlight than the first color R1 are mixed in a predetermined color distribution pattern.

(17) In the mixed region 112, the reflective layer obtained by dispersing the reflective material that contributes to an increase in the reflection rate of sunlight in the dispersion medium is provided in the location corresponding to at least the first color R1 out of the first color R1 and the second color R2.

(18) The heat input reducing structures 130, 130-1, 130-2, 130-3, 130-4, and 130-5 of the aircraft include the structural members forming the non-pressurized compartments C3 and C4 of the aircraft 2, and the heat blocking materials 131 and 141 which block the heat radiated from the heat source H located in the non-pressurized compartments C3 and C4 for the structural members. The structural members include the target regions 171A and 111A facing the heat source H via the heat blocking materials 131 and 141, and the mixed region 112 located on the outer surface of the airframe 10, and in which the first color R1 similar to the color applied to the region adjacent in the direction along the outer surface and the second color R2 having the lower absorption rate of sunlight than the first color R1 are mixed in a predetermined color distribution pattern.

(19) In the mixed region 112, the reflective material that contributes to an increase in the reflection rate of sunlight is provided in a part to which at least the first color R1 is applied.

(20) At least the target regions 171A and 111A of the structural members 171 and 111 are formed of the fiber reinforced resin, and the heat blocking materials 131 and 141 have the lower emissivity than the target regions 171A and 111A.

(21) The heat source H corresponds to the pipe through which the bleed air flows from engine 15 or the auxiliary power unit 16 of the aircraft.

(22) The gaps 134 and Ag are added between the target region and the heat blocking materials 131 and 141.

(23) The heat insulating material 132 that covers the target region from the inside of the non-pressurized compartments C3 and C4, and the heat blocking materials 131 and 141 disposed between the heat insulating material 132 and the heat source H are provided.

(24) The heat insulating material 132 is sealed between at least the heat blocking materials 131 and 141 out of the heat blocking materials 131 and 141 and other members and the structural members 171 and 111.

(25) The heat input reducing structure 130-4 includes the heat diffusing material 138 diffusing the heat by being disposed between the target region 171A and the heat blocking material 131, and the heat diffusing material 138 is provided with anisotropy for diffusing the heat in the plane direction of the target region 171A.

(26) The heat blocking material 141 corresponds to the laminate including the plurality of layers having the lower emissivity than the target region 171A.

(27) The non-pressurized compartment C3 corresponds to the inside of the belly fairing 17.

(28) The target region 171A corresponds to the side walls 17A and 17C of the belly fairing 17.

(29) The heat input reducing structure 130-2 includes the air supply path 137 that supplies the air to the vicinity of the target region 171A from the pressurized compartment C1 inside the fuselage 11.

(30) The non-pressurized compartment C4 corresponds to the compartment on the tail side from the pressure bulkhead W1 in the fuselage 11.

(31) The heat input reducing system 3 for the aircraft includes the heat input reducing structures 130, 130-1, 130-2, 130-3, 130-4, and 130-5 including the heat blocking materials 131 and 141, the fuselage 11 of the aircraft, the air conditioner 180 disposed in the non-pressurized compartment C3 inside the belly fairing 17 provided in the fuselage 11, and supplying the conditioned air to the pressurized compartment C1 inside the fuselage 11, the heat source H close to the target region 171A of the structural member 171 forming the belly fairing 17, the conditioned air distribution system s1 in which the conditioned air obtained from the air conditioner 180 by using the bleed air from the engine 15 or the auxiliary power unit 16 of the aircraft 2 is discharged outward of the aircraft from the non-pressurized compartment C3, while the conditioned air is circulated in the pressurized compartment C1 and the non-pressurized compartment C3,and the heat input reducing system s2 that reduces the heat input to the structural member 171 by using at least the heat blocking materials 131 and 141, even under a condition that the heat is radiated from the heat source H to the target region 171A and the sunlight is incident on the structural member 171 including the target region 171A.

### REFERENCE SIGNS LIST

1, 2, Aircraft

1A Cockpit

1B Cabin

1C Cargo compartment

1D, 1E Electronic device storage space

3 Heat input reducing system

5F Film preform

10 Airframe

10A Upper part

11 Fuselage

11A Skin

11B Liner

11C Accessory

11D Rear part

12 Main wing

13 Vertical tail

13A Side surface

14 Horizontal tail

15 Engine

16 Auxiliary power unit

17 Belly fairing

17A, 17C Side wall

17B Lower wall

17F Frame (Structural member)

17S Skin (Structural member)

18 Air conditioning system

19 Belly fairing

19A Side surface

19B Lower part

20 Radome

21 to 24 Pipe

25 Dado panel

26 Floor

27 Cabin underfloor space

28, 29 Accessory

30 Coating film structure

31 Black color coating film (First coating film)

32 Reflective coating film

33 White color coating film (Second coating film)

35 Roller (Transfer roller)

40 Coating film structure

42 Reflective coating film

43 White color coating film (Second coating film)

45 Masking sheet

50 Exterior film

51 Ink layer

52 Reflective layer

53 Adhesive layer

54 Release paper

60 Exterior film

61 Black color reflective support layer

62 White color applying part

101, 102, 103 Opening

110 Rear fuselage

110A Rear fuselage upper part

110S Skin

111 Structural member

111A Target region

112 Mixed region

113 Region

130 Heat input reducing structure

130A Laminate

131 Heat blocking material

132 heat insulating material

132A End edge

133 Tape (Other member)

134, Ag Air layer (Gap)

135, 136 Bracket

137 Air supply path

138 Heat diffusing material

141 Heat blocking material (Laminate)

141L Layer

171 Structural members

171A Target region

171B Recessed portion

180 Air conditioner

191 Accessory

192 Bleed air pipe

351 Pad

451 Through-hole

C1 Pressurized compartment

C2, C3, C4 Non-pressurized compartment

H Heat source

R1 First color

R2 Second color

s1 Conditioned air distribution system

s2 Heat input reducing system

W1 Pressure bulkhead

W2 Rear bulkhead

θ Central angle

1. A heat input reducing structure for an aircraft, wherein
an outer surface of a part of an airframe includes a mixed region in which a first color similar to a color applied to an adjacent region and a second color having a lower absorption rate of sunlight than the first color are mixed in a predetermined color distribution pattern, and
a reflective material that contributes to an increase in a reflection rate of sunlight is added to a part to which at least the first color is applied in the mixed region.

2. The heat input reducing structure for an aircraft according to claim 1, wherein in the mixed region, a ratio of an area occupied by the second color gradually increases upward from below.

3. The heat input reducing structure for an aircraft according to claim 2, wherein the mixed region is located above the adjacent region to which a color similar to the first color is applied.

4. The heat input reducing structure for an aircraft according to claim 1, wherein a part of the first color and a part of the second color in the mixed region form the color distribution pattern in which basic shapes are regularly or irregularly disposed.

5. (canceled)

6. The heat input reducing structure for an aircraft according to claim 1, wherein the mixed region is located in a vicinity of a vertical tail erected from a fuselage forming the airframe, in the fuselage.

7. The heat input reducing structure for an aircraft according to claim 1, wherein the mixed region is located on a side surface in a fairing provided on a lower side of a fuselage forming the airframe, or a side surface in a vertical tail forming the airframe.

8. The heat input reducing structure for an aircraft according to claim 7, wherein a member forming the part of the airframe where the mixed region is located is formed of a fiber reinforced resin.

9. The heat input reducing structure for an aircraft according to claim 1, wherein a non-pressurized compartment which is not pressurized exists inside the part of the airframe where the mixed region is located.

10. The heat input reducing structure for an aircraft according to claim 1, wherein a compartment where a heat source is disposed exists inside the part of the airframe where the mixed region is located.

11. The heat input reducing structure for an aircraft according to claim 1, wherein a compartment on which at least temperature control out of forced ventilation and the temperature control is not performed by an air conditioning system included in the aircraft exists inside the part of the airframe where the mixed region is located.

12. An aircraft comprising:
an airframe; and
the heat input reducing structure according to claim 1, which is applied to a part of the airframe.

13. An aircraft manufacturing method for manufacturing an aircraft after coating an airframe, comprising:
a step of forming a first coating film by applying a coating material of a first color similar to a color applied to an adjacent region in a predetermined color distribution pattern, to a mixed region located on an outer surface of a part of the airframe; and
a step of forming a second coating film formed by transferring a coating material of a second color having a lower absorption rate of sunlight than the first color so that the first color and the second color are mixed.

14. An aircraft manufacturing method for manufacturing an aircraft after coating an airframe, comprising:
a step of forming a first coating film by applying a coating material of a first color similar to a color applied to an adjacent region in a predetermined color distribution pattern, to a mixed region located on an outer surface of a part of the airframe; and
a step of forming a second coating film formed by using a coating material of a second color having a lower absorption rate of sunlight than the first color after masking a location to which the first color is applied so that the first color and the second color are mixed.

15. The aircraft manufacturing method according to claim 13 [[or 14]], further comprising:
a step of applying a coating material containing a reflective material that contributes to an increase in a reflection rate of sunlight to a location to which at least the first color out of the first color and the second color is applied.

16.-17. (canceled)

18. A heat input reducing structure for an aircraft, comprising:
a structural member forming a non-pressurized compartment of the aircraft; and
a heat blocking material that blocks heat radiated from a heat source located in the non-pressurized compartment for the structural member, wherein
the structural member includes
a target region facing the heat source via the heat blocking material, and
a mixed region located on an outer surface of an airframe, in which a first color similar to a color applied to an adjacent region in a direction along the outer surface and a second color having a lower absorption rate of sunlight than the first color are mixed in a predetermined color distribution pattern.

19. The heat input reducing structure for an aircraft according to claim 18, wherein a reflective material that contributes to an increase in a reflection rate of sunlight is added to a part to which at least the first color is applied in the mixed region,

20. The heat input reducing structure for an aircraft according to claim 18, wherein
at least the target region of the structural member is formed of a fiber reinforced resin, and
the heat blocking material has lower emissivity than the target region.

21. The heat input reducing structure for an aircraft according to claim 18, wherein the heat source corresponds to a pipe through which bleed air flows from an engine or an auxiliary power unit of the aircraft.

22. The heat input reducing structure for an aircraft according to claim 18, wherein a gap is provided between the target region and the heat blocking material.

23. The heat input reducing structure for an aircraft according to claim 18, further comprising:
a heat insulating material that covers the target region from an inside of the non-pressurized compartment, wherein
the heat blocking material disposed between the heat insulating material and the heat source.

24. The heat input reducing structure for an aircraft according to claim 23, wherein the heat insulating material is sealed between at least the heat blocking material out of the heat blocking material and other members and the structural member.

25. The heat input reducing structure for an aircraft according to claim 18, further comprising:
a heat diffusing material disposed between the target region and the heat blocking material to diffuse heat, wherein
the heat diffusing material is provided with anisotropy for diffusing the heat in a plane direction of the target region.

26. The heat input reducing structure for an aircraft according to claim 18, wherein the heat blocking material corresponds to a laminate including a plurality of layers having lower emissivity than the target region.

27. The heat input reducing structure for an aircraft according to claim 18, wherein the non-pressurized compartment corresponds to an inside of a belly fairing.

28. The heat input reducing structure for an aircraft according to claim 27, wherein the target region corresponds to a side wall of the belly fairing.

29. The heat input reducing structure for an aircraft according to claim 27, further comprising:
an air supply path for supplying air to a vicinity of the target region from a pressurized compartment inside a fuselage.

30. The heat input reducing structure for an aircraft according to claim 18, wherein the non-pressurized compartment corresponds to a compartment on a tail side from a pressure bulkhead in a fuselage.

31. A heat input reducing system for an aircraft, comprising:
the heat input reducing structure according to claim 18;
a fuselage of the aircraft;
an air conditioner disposed in the non-pressurized compartment inside a belly fairing provided in the fuselage, and supplying conditioned air to a pressurized compartment inside the fuselage;
a heat source close to the target region of the structural member forming the belly fairing;
a conditioned air distribution system in which the conditioned air obtained from the air conditioner by using bleed air from an engine or an auxiliary power unit of the aircraft is discharged outward of the aircraft from the non-pressurized compartment, while the conditioned air is circulated in the pressurized compartment and the non-pressurized compartment; and
a heat input reducing system that reduces a heat input to the structural member by using at least the heat blocking material, even under a condition that the heat is radiated from the heat source to the target region and the sunlight is incident on the structural member including the target region.
